(19) United States
(12) Patent Application Publication
(10) Pub. No.: US 2001/0005830 A1
(43) Pub. Date: Jun. 28, 2001

(54) Information medium with respect to food and drink, health control terminal and health control support system

(76) Inventor: Tadashi Kuroyanagi, Tokyo (JP)

Correspondence Address: Ernest I. Gifford, Suite 400, 280 N. Woodward Avenue, Birmingham, MI, 48009, US

(21) Appl. No.: 09/749,051

(22) Filed: Dec. 27, 2000

(30) Foreign Application Priority Data
Dec. 27, 1999 (JP) 371884/1999

(51) Int. Cl. G06F 17/60

(52) U.S. Cl. 705/2; 705/3

(57) ABSTRACT

The object of the present invention is that the quantity of the energy of the ingested food and drink can be accurately and permanently recorded and reliable effects can be expected from the diet therapy and the healthy slimming. The ingested energy of the food and drink or the searching information for searching this ingested energy of the food and drink are patterned in a predetermined format and recorded in the information medium associated with the food and drink. Then, the person who requires the diet therapy or the like reads and decodes the above patterned information by using the health control terminal, which is brought with oneself to transmit the decoded information to the control device having the data base. The control device returns this energy information of the food and drink or the health control information associated with this energy information, so that this information is displayed on the health control terminal.

### BACKGROUND OF THE INVENTION

1. Field of the Invention

The present invention relates to an art for easily controlling hearth with respect to meal.

2. Description of the Related Art

Conventionally, a medical institution has instructed a person who are required to take a diet therapy and healthy slimming to record quantity of energy in food compositions, which are included the person's meal.

On this account, the person who is instructed in such a manner as this, should make a meal in accordance with a recipe made by a dietitian or the like at home, record quantity of energy, which is described in the recipe. Further, in the case of eating out at an eating establishment such as a restaurant or the like, the person who is instructed in such a manner as this, should conject the weight of each foodstuff which is included in the ingested food and drink, calculate and record by handwriting the quantity of the energy of the food composition on the basis of a list of food exchange or the like, to be issued by Japanese Diabetes Association or the like, which describes the quantity of the energy per weight included in various foods so that he or she submits this record to the medical institution or the like and receives the guidance.

However, the work for calculating and storing the quantity of the energy of the food and drink from the weight that is conjected in such a manner as this, not only lacks accuracy, but also is very complicate. Therefore, a majority of persons who are instructed to take the diet therapy and the healthy slimming is not capable of recording permanently the quantity of the energy, which is supplied from the ingested meal and the information with respect to the ingested meal is not accurate. As a result, it is impossible to expect effects from the diet therapy and the healthy slimming.

### SUMMARY OF THE INVENTION

The present invention has been made taking the above-described problems into consideration, an object of which is to provide an information medium with respect to food and drink, a health control terminal and a health control support system, by which the quantity of the energy of the ingested food and drink can be accurately and permanently recorded and reliable effects can be expected from the diet therapy and the healthy slimming.

In order to attain the above object, the information medium according to a first aspect of the present invention comprises an information medium associated with a food and drink, including the information medium such as a package or the like of a meal menu and the food and drink, wherein information showing an ingested energy of each food and drink is patterned in a predetermined format and recorded.

The health control terminal so as to be portable according to a second aspect of the present invention comprises reading means for reading a record, which is patterned in a predetermined format as information showing an ingested energy of a food and drink in an information medium associated with the food and drink, decoding means for decoding the ingested energy of the food and drink from the read information of the reading means, transmitting means for transmitting a radio signal for transferring the energy information, which is decoded by the decoding means, to a predetermined device, receiving means for receiving a radio signal to be returned with respect to the radio signal, which is transmitted by the transmitting means, as health control information of a person who brings the health control terminal with oneself associated with the ingested energy of the food and drink and informing means for informing the health control information, which is received by the receiving means.

The health control terminal so as to be portable according to a third aspect of the present invention comprises reading means for reading a record, which is patterned in a predetermined format as searching information for searching an ingested energy of a food and drink in an information medium associated with the food and drink, decoding means for decoding the searching information from the read information of the reading means, transmitting means for transmitting a radio signal for transferring the searching information, which is decoded by the decoding means, to a predetermined device, receiving means for receiving a radio signal to be returned with respect to the radio signal, which is transmitted by the transmitting means, as health control information of a person who brings the health control terminal with oneself associated with the ingested energy of the food and drink, which is searched by the searching information and informing means for informing the received health control information, which is received by the receiving means.

The health control terminal so as to be portable according to a fourth aspect of the present invention comprises physical exercise quantity measuring means for measuring the physical exercise quantity of a person who brings the health control terminal with oneself, reading means for reading a record, which is patterned in a predetermined format as searching information for searching an ingested energy information of a food and drink in an information medium associated with the food and drink, decoding means for decoding the searching information from the read information of the reading means, transmitting means for transmitting a radio signal for transferring the physical exercise quantity, which is measured by the physical exercise quantity measuring means or the searching information, which is decoded by the decoding means, to a predetermined device, receiving means for receiving a radio signal to be returned with respect to the radio signal, which is transmitted by the transmitting means in order to transfer the searching information to a predetermined device, as health control information of a person who brings the health control terminal with oneself associated with the ingested energy of the food and drink, which is searched by the searching information and informing means for informing the received health control information, which is received by the receiving means.

The health control terminal of a fifth aspect of the present invention according to the second aspect, the third aspect or the fourth aspect has a function of a cellular phone to enable a phone call by voice.

The health control terminal of a sixth aspect of the present invention according to the second aspect, the third aspect, the fourth aspect 4 or the fifth aspect has means for inputting and setting the information, which is decoded by the decoding means, as various parameters, which are necessary for the operation of the terminal.

The health control terminal of a seventh aspect of the present invention according to the second aspect, the third aspect, the fourth aspect 4, the fifth aspect or the sixth aspect has a detachable storage medium and means for reading and writing the information, which is necessary for the health control of the person who brings the health control terminal with oneself, with respect to the storage means.

The health control support system according to an eighth aspect comprises a health control terminal to be brought with a person who requires a diet therapy and health slimming, a control device having a data base, in which the information associated with the health of each person who brings the health control terminals with oneself is stored and a network for enabling transmission and reception of the information between the health control terminal and the control device; wherein the health control terminal comprises reading means for reading a record, which is patterned in a predetermined format as information showing an ingested energy of a food and drink in an information medium associated with the food and drink, decoding means for decoding the ingested energy of the food and drink from the read information of the reading means, transmitting means for transmitting a radio signal for transferring the energy information, which is decoded by the decoding means, to the control device, receiving means for receiving a radio signal to be returned with respect to the radio signal, which is transmitted by the transmitting means, as health control information of a person who brings the health control terminal with oneself associated with the ingested energy of the food and drink and informing means for informing the health control information, which is received by the receiving means; wherein the control device is constructed in such a manner that it returns the health control information, which is necessary for the diet therapy and the health slimming of the person who brings the health control terminal with oneself, associated with the ingestion of the food and drink and stores the ingested energy information of the person who brings the health control terminal with oneself on the basis of the energy information to be transmitted from the health control terminal and the information of the person who brings the health control terminal with oneself, which is stored in the data base.

The health control support system according to a ninth aspect comprises a health control terminal to be brought with a person who requires a diet therapy and health slimming; a control device having a data base, in which the information showing an ingested energy of a food and drink, which is provided by a catering establishment and the food and drink, which is sold by a delicatessen shop is stored in advance; and a network for enabling transmission and reception of the information between the health control terminal and the control device; wherein the health control terminal comprises reading means for reading a record, which is patterned in a predetermined format as searching information for searching the ingested energy information of the food and drink in an information medium associated with the food and drink, decoding means for decoding the searching information from the read information of the reading means, transmitting means for transmitting a radio signal for transferring the searching information which is decoded by the decoding means, to the control device, receiving means for receiving a radio signal to be returned with respect to the radio signal, which is transmitted by the transmitting means, as health control information of a person who brings the health control terminal with oneself associated with the ingested energy of the food and drink, which is searched by the searching information and informing means for informing the health control information, which is received by the receiving means; wherein the control device is constructed in such a manner that it returns the energy information of the food and drink, which is searched by the searching information to be transmitted from the health control terminal, in the energy information of the food and drink, which is stored in the data base, as the health control information, which is necessary for the diet therapy and the healthy slimming of the person who brings the health control terminal with oneself and stores the ingested energy information of the person who brings the health control terminal with oneself.

In the health control support system of a tenth aspect according to the eighth aspect or the ninth aspect, the network is connected to a terminal device of specific institutions including a medical institution for instructing the health control to the person who brings the health control terminal with oneself so as to access the ingested energy information of each person who brings the health control terminal with oneself, which is stored in the data base of the control device.

### BRIEF DESCRIPTION OF THE DRAWINGS

FIG. 1 shows a meal menu as an example of an information medium according to the present invention;

FIG. 2 shows an energy of a food and drink, which is displayed on the meal menu in FIG. 1, for each nutritional element;

FIG. 3 shows a health control terminal and a health control support system according to the present invention;

FIG. 4 is a whole structural diagram of the health control support system according to an embodiment of the present invention;

FIG. 5 is a block diagram showing the constitution of the health controlling terminal according to the embodiment of the present invention;

FIG. 6 is a block diagram showing the constitution of a network computer to be used for the health control support system according to the embodiment of the present invention;

FIG. 7 is one example of the information medium to be used for the health control support system according to the embodiment of the present invention;

FIG. 8 is a flow chart showing the operation of the health control support system according to the embodiment of the present invention;

FIG. 9 is a flow chart showing the operation of the health control support system according to the embodiment of the present invention;

FIG. 10 shows the appropriate energy for each nutritional element, which is ingested in a day;

FIG. 11 shows a graph of the appropriate energy for each nutritional element, which is ingested in a day;

FIG. 12 is a block diagram showing a constitution of the health control terminal according to the embodiment of the present invention;

FIG. 13 shows an appearance of the health control terminal according to the embodiment of the present invention;

FIG. 14 shows a whole constitution of the health control support system according to the embodiment of the present invention;

FIG. 15 shows an example of the information medium according to the embodiment of the present invention;

FIG. 16 shows the energy quantity for each nutritional element included in the food and drink and the energy quantity, which can be ingested in a day;

FIG. 17 shows an example of a graph, which is displayed on the health control terminal according to the embodiment of the present invention;

FIG. 18 is a flow chart for explaining the operation of the health control terminal according to the embodiment of the present invention; and

FIG. 19 is a flow chart explaining the operation of the health control terminal according to the embodiment of the present invention.

### DESCRIPTION OF THE PREFERRED EMBODIMENTS

The embodiment of the present invention will be explained with reference to the drawings.

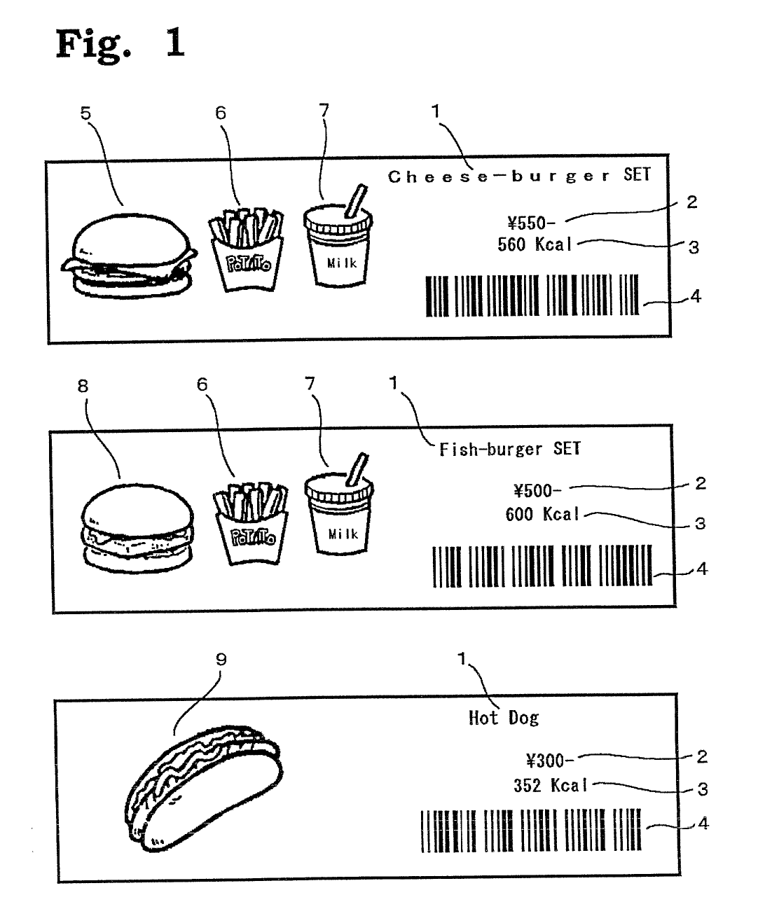

FIG. 1 shows one example of meal menus as an embodiment of the information medium according to the food and drink of claim 1 of the present invention.

In FIG. 1, a reference numeral 1 denotes a name of the food and drink (in this example, a cheeseburger set), a reference numeral 2 denotes a price of the food and drink, a reference numeral 3 denotes a quantity of the ingested calorie of the food and drink and a reference numeral 4 denotes a patterned and printed record of the ingested calorie as the ingested energy of the food and drink in a predetermined format (in this example, a bar code format).

Alternatively, the reference numerals 5 to 7 show visual images of the food and drink. In this example, the reference numeral 5 shows a visual image of a cheeseburger, the reference numeral 6 shows a visual image of a fried potato and the reference numeral 7 shows a visual image of milk.

Here, as the patterned record 4 comprising patterned information of the ingested energy of the food and drink, any predetermined format may be applied, in which an original information can be read and decoded. Also, the recording format thereof may be a pattern, which is capable of being read by a magnetic reading devise such as a magnet stripe or a non-contact type IC in addition to an optical barcode and mosaic or the like.

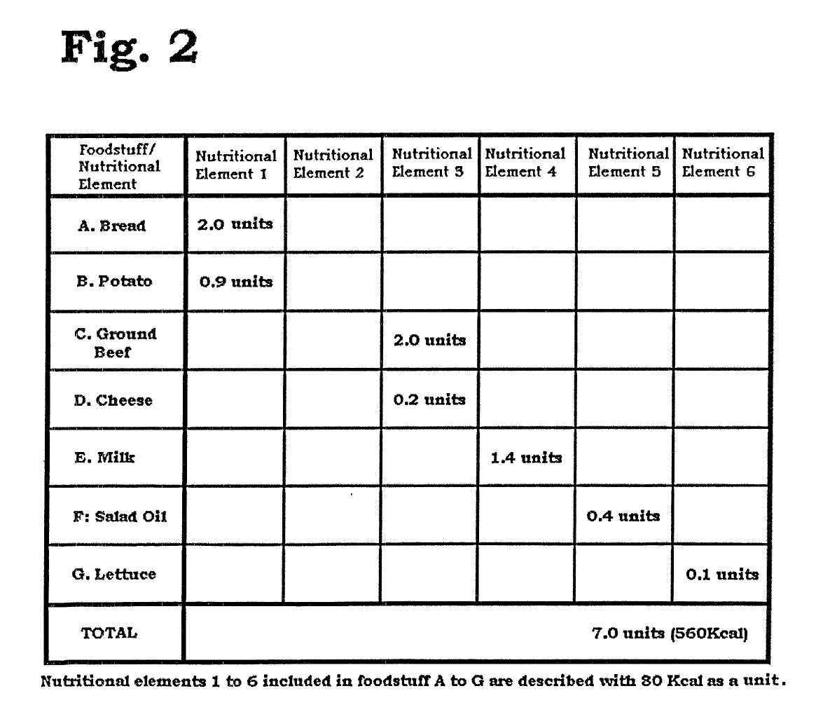

FIG. 2 shows a content of the information included in the record 4 of the cheeseburger set of the meal menu in FIG. 1.

In FIG. 2, alphabetic characters of A to G represent foodstuffs used for the cheeseburger set. A represents bread of 60 gram, B represents a potato of 90 gram, C represents a ground beef of 60 gram, D represents cheese of 5 gram, E represents milk of 200 cc, F represents salad oil of 4 gram and G represents lettuce of 10 gram.

Furthermore, nutritional elements 1 to 6 show quantity of the nutritional elements, which are included in the foodstuffs A to G. The nutritional element 1 is composed of the food group including much carbohydrate except for fruits, the nutritional element 2 is composed of fruits including much carbohydrate, the nutritional element 3 is composed of the food group including much nutrition such as a protein, a fat, a vitamin, calcium and phosphor or the like, the nutritional element 5 is composed of the food group supplying fat and the nutritional element 6 is composed of vegetables including small quantity of energy, which supplies a vitamin and a mineral.

The quantity in a table shown in FIG. 2 is obtained in such a manner that the quantity of energy of the nutritional element included in respective foodstuffs, i.e., kilo calorie is calculated to determine this calculated calorie quantity as a unit of 80 kilo calories. The value obtained by multiplying this sum by 80 is a calorie quantity 3 of the cheeseburger set, which is indicated in the meal menu in FIG. 1.

The sum of calories with respect to the above-described respective nutritional elements 1 to 6 is patterned and indicated in the record 4 indicated which is patterned and indicated in the above-described meal menu.

Therefore, when the record 4 indicated which is patterned in this meal menu is read and decoded by a barcode reading device or the like, it is possible to find accurately the energy which is ingested from the food and drink for each nutritional element, so that the record 4 is capable of serving to control the health of a person who requires the diet therapy and the healthy slimming.

Here, the energy information of respective food and drink is patterned and recorded in the meal menu. However, in the case of a delicatessen shop, in which the food an drink are sold without being cooked, it is also possible to pattern and record the energy information for each nutritional element, which is included in the food and drink, on package papers of the food and drink to be sold.

Alternatively, in the case of having a meal, which is cooked depending on a predetermined meal menu card or the like at home or the like, it is also possible to pattern and record the energy information for each nutritional element, which is included in the meal of the meal menu card or the like.

Next, a summary of the health control terminal and the health control support system for controlling the health by reading this patterned record of the energy information of the food and drink will be explained below.

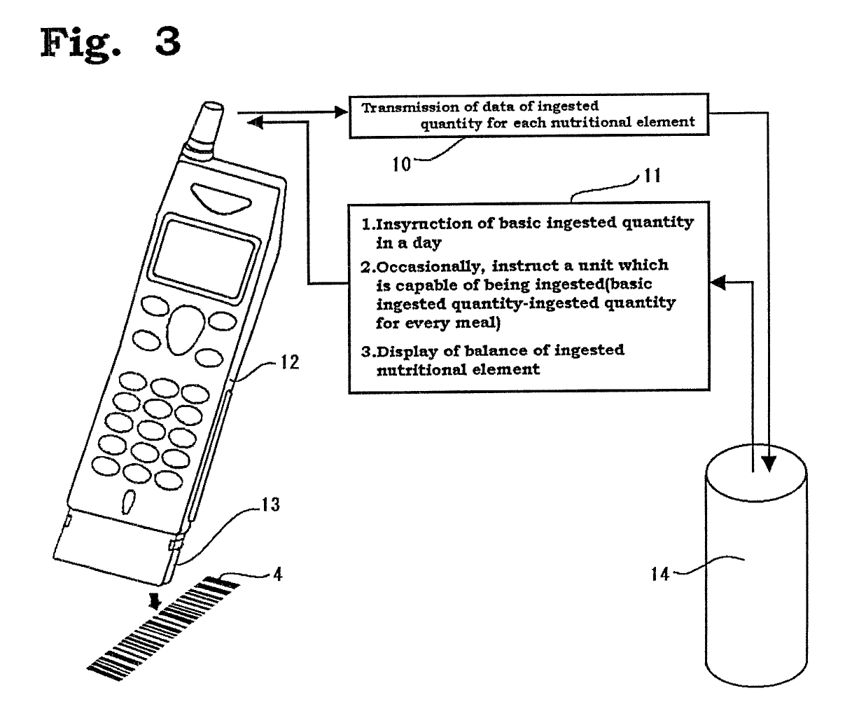

FIG. 3 shows a schematic view of this health control support system. In FIG. 3, a database 14 registers in advance, for example, data with respect to one's life such as sex, age and working condition or the like and measured data such as body height, body weight, body fat ratio, blood sugar level and blood pressure or the like as an individual data of the person who requires the diet therapy and the healthy slimming (hereinafter, referred to as an applied person).

This data base 14 is installed within a controlling apparatus (not illustrated) connected to a circuit network, which is capable of being accessed from a health controlling terminal 12, which is integrated to a cellular phone. This controlling apparatus calculates an appropriate quantity of the food ingestion, which the applied person ingests in a day and stores it. At the same time, the controlling apparatus transmits the calculated data to the health controlling terminal 12 of the applied person at a predetermined time, for example, every morning.

The health controlling terminal 12 includes a function as a cellular phone. The health controlling terminal 12 has a reading device 13 for reading a record, which is patterned in the above-described meal menu, a device for decoding the read information of this reading device 13 and transmitting automatically the decoded energy information to the above-described controlling apparatus and a device for receiving the returned data from the controlling apparatus to inform this received information as a health control information so that a person who brings the health controlling terminal 12 with oneself can confirm, for example, indicating by an indication unit or announcing by voice.

In other words, as described in claim 2, this portable health controlling terminal 12 comprises a reading device for reading the record, which is patterned in a predetermined format in the information medium associated with the food and drink as the information showing the ingested energy of the food and drink, a decoding device for decoding the ingested energy of the above-described food and drink from this reading device, a transmitting device for transmitting radio signals to transmit the decoded energy information to a predetermined apparatus, a receiving device for receiving the radio signals to be returned with respect to the transmitted radio signals as a health control information of a person who brings the portable health controlling terminal 12 associated with the above-described ingested energy of the above-described food and drink and an informing device, which informs the received health control information, oneself.

Therefore, even without performing inaccurate conjecture and a complicate calculation, it is possible to obtain an accurate ingested information by a simple operation to read the ingested energy of the food and drink from the information medium.

Alternatively, according to this health control support system, the applied person ingests in numbers an appropriate ingested meal quantity of a returned data 11 to be returned from the controlling apparatus at a predetermined time. For example, in the case of ingesting the above-described cheeseburger set as a lunch, the record 4 indicated in the meal menu with a bar code is read and decoded by the reading device 13, which is installed in the health controlling terminal 12, so that the energy quantity for each nutritional element included in the ingested cheeseburger set is recognized and a numeric value of the energy quantity is transmitted to the controlling apparatus to be stored in the data base 14.

The controlling apparatus transmits occasionally the returned data 11 to the health controlling terminal 12. The returned data 11 comprises a numeric vale which is obtained by subtracting the transmitted data 10 from the appropriate ingested meal quantity which the applied person ingests in a day, which is stored in the data base 14 in advance, namely, a numeric value, which is capable of being ingested by the applied person.

The applied person is capable of confirming a meal quantity, which can be ingested, by the returned data 11 to be returned from the data base 14 and controlling the ingested quantity of the meal in a day.

On this account, it is possible to support efficiently self-control of the meal ingested quantity of the applied person. Further, the medical institution accesses the data base 14 of the controlling apparatus, reads the data of the ingested quantity of the meal of the applied person, which is stored in the data base 14 and analyzes the data, so that it is possible to prescribe the appropriate ingested quantity of the meal and instruct it to the applied person more speedy and accurately.

As described in claim 8, this health control support system reads and decodes the record patterned in a predetermined format in the information medium associated with the food and drink by the portable health controlling terminal 12. Then, the health control support system transmits the decoded energy information to the controlling apparatus and receives the returned information from the controlling apparatus, so that the person who brings with the portable health controlling terminal 12 oneself is capable of confirming this returned information.

Therefore, there is no need for the applied person to conject the energy quantity of the food and drink by oneself upon eating out. Further, the applied person is capable of recording the ingested energy information easily and accurately in the data base 14 of the controlling apparatus. As a result, it is possible to obtain a reliable effect with respect to the diet therapy and the healthy slimming by ingesting the food and drink depending on the instruction from the controlling apparatus.

Alternatively, the above-described health controlling terminal 12 has a cellar phone function, namely, a phone call function. However, as described above, the health controlling terminal 12 is not required to have a phone call function for controlling health, so that only a function to transmit the energy information which is recorded and decoded by the reading device 13 to the controlling apparatus and inform the health control information, which is received form the controlling apparatus may be enough for the health controlling terminal 12 to control the health.

Next, the health controlling terminal having a device for reading and decoding the record patterned in a predetermined format in a printing unit associated with the food and drink as described above and the health control support system in use of this health controlling terminal will be specifically explained below.

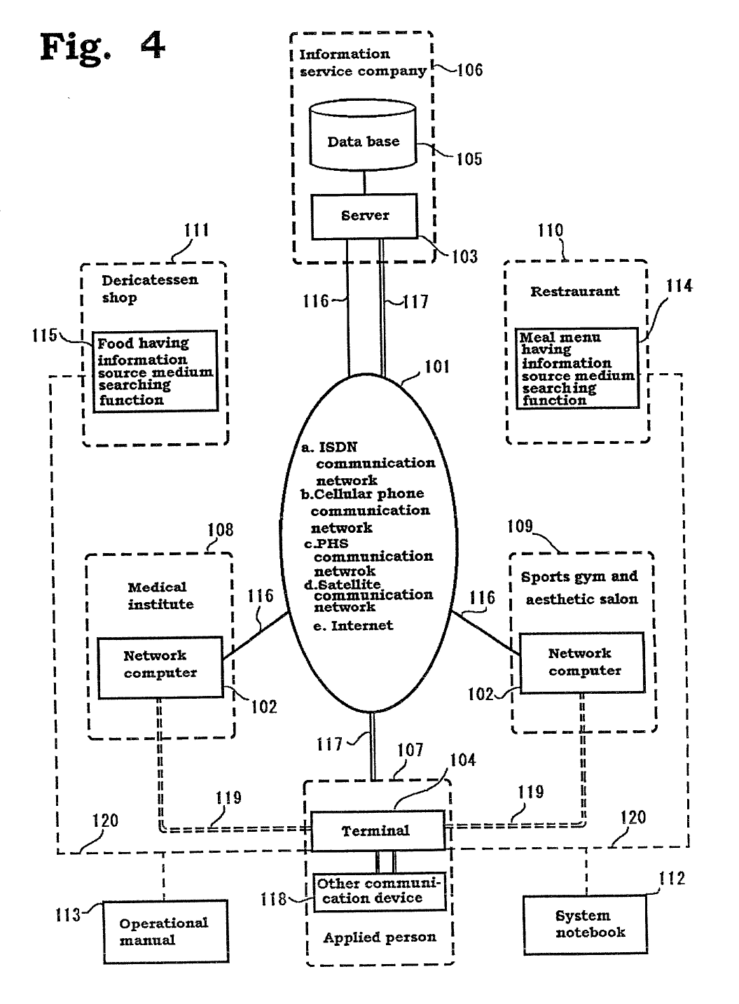

FIG. 4 shows a whole structural diagram of the health control support system. In FIG. 4, a reference numeral 101 denotes communication networks configured by an ISDN communication network 101a, a cellular phone communication network 101b, a PHS communication network 101c, a communications satellite communication network 101d and an internet 101e.

In these communication networks 101, a plurality of network computers 102 (hereinafter, referred to as NC 102) and a server 103 or the like are connected to the ISDN communication network 101a and the internet 101e. The NC 102 are connected to a group of the medical institution 108 or the like for instructing the diet therapy for a life habit disease and a group composing of a sports gym and an aesthetic salon 109 or the like for instruction the diet therapy for the healthy slimming.

Alternatively, the server 103, which is installed in an information service company 106 is capable of being accessed from the above-described NC 102 and the health controlling terminal 104 and it is provided with a data base 105.

Further, the cellular phone communication network 101b, the PHS communication network 101c and the communications satellite communication network 101d are connected with a communication device associated with respective communication networks 101. In these communication networks 101, for example, the health controlling terminal 104 including the function as the cellular phone is connected to a cellular phone communication network 101b. This health controlling terminal 104 is brought with, for example, the applied person 107 who requires the diet therapy for the life habit diseases such as a diabetes and a high blood pressure and the diet therapy for the healthy slimming.

Judging whether the user identification information (hereinafter, referred to as ID), which is inputted from respective NC 102 and the health controlling terminal 104 is correct or not, if it is correct, the NC 102 reads the user interface information of the corresponding user from the data base 105, supplies an application program which is required by the NC 102 and transmits the data.

Alternatively, the health controlling terminal 104 reads and transfers an individual information of the applied person 7 from the data base 105 and enables to access the data base 105. The health controlling terminal 104, further, searches the data base 105 on the basis of a search information transmitted from the health controlling terminal 104, reads the data stored in the corresponding address and transfers the data to the health controlling terminal 104. Additionally, the health controlling terminal 104 enables to access the data base 105 in which various data such as a medical information and an individual information of the corresponding applied person or the like are stored.

The data base 105 of an information service company 106 is capable of being searched from the NC 102 and the health controlling terminal 104 via the server 103. In this data base 105, various information are stored, such as data of energy for each nutritional element included in various foods and drinks sold in a delicatessen shop 111 and the cooked food of a restaurant 110, information for instructing an appropriate meal quantity to be ingested in a day by the applied person 107, an individual information, which is specific for the applied person 107, such as an ecological measured information of a blood sugar level and a blood pressure level, a medical information in a medical institute 8, an information associated with the healthy slimming in the sports gym and an aesthetic salon 109 and service information for the applied person 107.

In these information, the data of energy for each nutritional element are stored in the server 103 with addresses in which the energy quantity data for each nutritional element is divided roughly for each manufacture and classified for each commodity name. The energy quantity data for each nutritional element are calculated by classifying the energy quantity included in various foods, which are sold in the delicatessen shop 111 and the cooked foods served in the restaurant 110, respectively, for each nutritional element, such as a vitamin, mineral, a carbohydrate, a fat and a protein or the like. Alternatively, other various information are roughly divided into the group of the applied person 107, the group of the medical institution 108 and the group of the sports gym and the aesthetic salon 109 to be stored in the server 103.

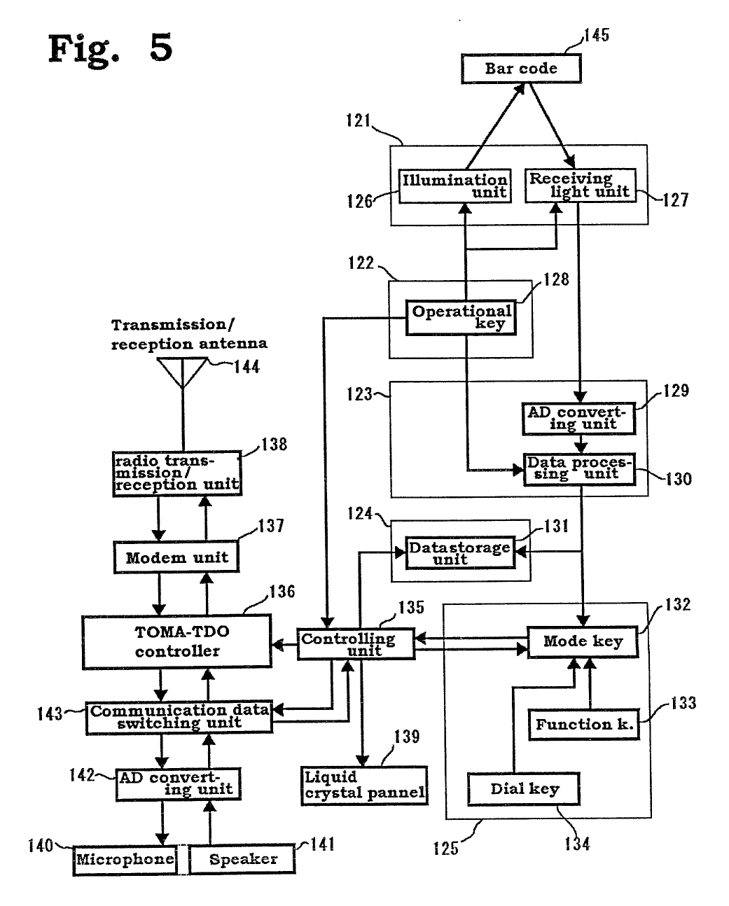

FIG. 5 is a block diagram showing the constitution of the health controlling terminal 104. The constitution and the operation thereof are explained below. At first, a power source key of the health controlling terminal 104 has been pushed down for a predetermined period of time, for example, one second and above to turn the power source on so that the health controlling terminal 104 is put in hold-on. In this situation, a communication data switching unit 143 normally selects a phone call and an input switching device 125 of the health controlling terminal 104 selects key inputting.

In the case of speaking through the health controlling terminal 104, pushing down a mode key 132 plural times to select a dial key 134 and pushing down a dial key 134 plural times to select a calling number allows other communication device to be called, so that a speaker can speaks through the other communication device. In the case of setting the functions of the health controlling terminal 104, pushing down the mode key 132 plural times to select a function key 133, pushing down the function key 133 plural times to select a function to be set and using freely the dial key 134 to input characters and numerals allows a function such as registering telephone numbers or the like to be set.

Next, the operation in the case of selecting bar code input will be explained below. Pushing down an operational key 128 of a control device 122 sequentially to activate a dialer of a communication device controlling unit 135 which controls the health controlling terminal 104, the server 103 is called and the health controlling terminal 104 is connected to the server 103. In this operation, while pushing down the operational key 128, a reading device 121 becomes possible to be operated. On this account, a semiconducting laser 126 of the reading device 121 emits the laser ray. If this laser ray is emitted to characters or figures, for example, a bar code 145, a photo diode 127 receives the reflection light from the bar code 145 and the photo diode 127 outputs a weak analog signal in a bar (black) portion and emits a strong analog signal in a space (white).

The analog signal to be inputted from the photo diode 127 is inputted in an AD converting unit 129 to be converted into a digital signal. Further, the digital signal, which is converted in the AD converting unit 129, is inputted in a CPU 130 and processed. Then, a pattern of the bar code 145, which is read by a reading device 121, is converted to various data, for example, an ID of the applied person 107 and a calling number of the server 103, or searching information of the data base 105 or the like.

The health controlling terminal 104 inputs the ID, which is inputted from the NC 102 and stored therein, in the server 103. Then, the server 103 judges whether the ID is correct or not. If the ID is correct, the server 103 reads an individual data of the applied person 107 from the data base 105 and transfers it. At the same time, the server 103 enables the access between the health controlling terminal 104 and the data base 105. Then, the server 103 searches the data base 105 on the base of the searching information to be transferred from the health controlling terminal 104 and reads the corresponding information to transfer it to the health controlling terminal 104.

The health controlling terminal 104 inputs the data for the communication transferred from the server 103 in a modem unit 137. Then, the health controlling terminal 104 reads the demodulated data, namely, the bar code 145 described in, for example, the cheeseburger set, in a meal menu having a searching function 114 as information source medium (information medium) by the reading device 121, searches the data base 105 by using the obtained searching information, reads the energy quantity data for each nutritional element included in the corresponding cheeseburger set, transfers it to the health controlling terminal 104 to write and store it in a RAM 13 and indicate it on a liquid crystal panel 139.

Alternatively, the searching information of various data associated with a meal such as the energy quantity for each nutritional element included in various kinds of food in advance and the energy quantity to be consumed by physical exercises may be described in advance by using characters or figures, for example, the bar code 145 in any information source medium, for example, a system notebook 112, then, the bar code 145 may be read by the reading device 121. Further, the data base 105 may be searched by using the obtained searching information, the corresponding information may be read to be transferred to the health controlling terminal 104. Then, the corresponding information may be written and stored in the RAM 131 of the storing device 104 and be indicated on the liquid crystal panel 139.

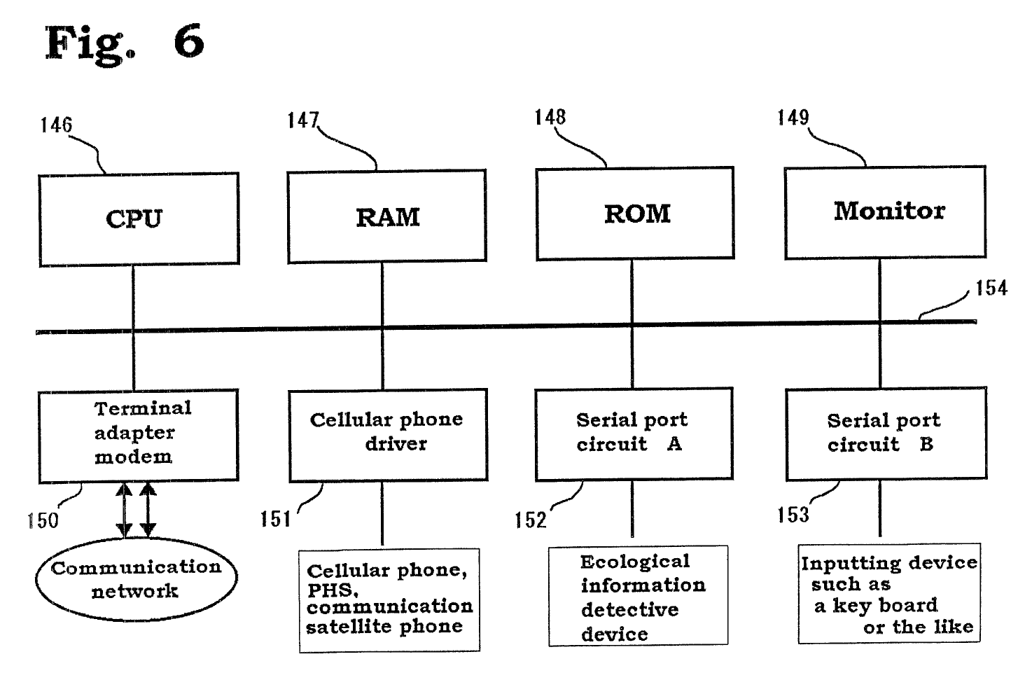

FIG. 6 is a block diagram showing the constitution of the NC 102. In the NC 102, a minimum program is stored in a ROM 148 to carry out the program, which is connected to the server 103 and downloaded therein on the basis of access information to be inputted from an inputting device, such as a key board.

Alternatively, the NC 102 is provided with a CPU 146 for the NC, for processing data as other circuit, a RAN 147 for a recording medium NC, which is capable of reading and writing occasionally, a monitor 149, a terminal adapter and a communication modem 150, a driver controlling circuit 151 for inputting various information in the health controlling terminal 104, a serial port circuit A152 of a RS-232C for connecting an ecological information measuring instrument or the like, a serial port circuit B153 of the RS-232C for connecting a keyboard and a data inputting device and a pass 154.

Being occasionally connected to the health controlling terminal 104, meal controlling information which is specific for the applied user 107, the ID and calling information of the server 103 or the like are inputted with respect to the health controlling terminal 104 from the server 103 in the above-described driver controlling circuit 151. Alternatively, the ecological information measuring instrument such as a blood sugar measuring instrument and a blood pressure measuring instrument or the like is connected to the serial port circuit A152. The measured data of the blood sugar, which is measured by the applied person is automatically inputted, for example, in the blood sugar measuring instrument from this measuring instrument as the RS-232C signal. The serial port circuit B153 is connected with the data inputting device and the calling number of the server 103 and the ID are inputted in the serial port circuit B153.

Further, operational information such as an initial screen and various kinds of data or the like are indicated on the monitor 149 and each circuit of the communication network 101 is connected to a terminal adapter and the communication modem 150. For example, the NC 102 and the server 103 are connected to the ISDN circuit 101a.

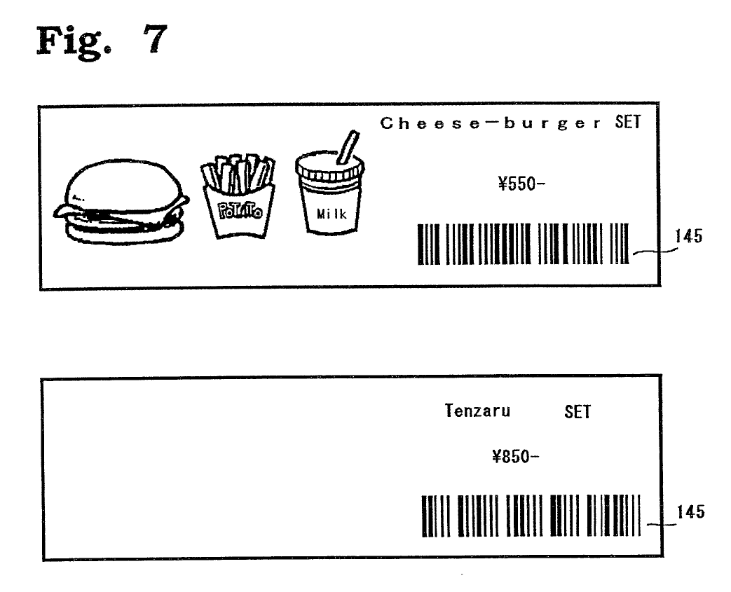

FIG. 7 is one of the above-described information source medium. FIG. 7 shows the meal menu having a searching function 114, for example, the cheeseburger set including a cheeseburger, a fried potato and milk and a tenzaru set including a zaru-soba and tempura. In FIG. 7, the searching information for searching names of the foods and drinks, selling prices thereof and the energy quantity data for each nutritional element included in respective foods, i.e., the address of the data base 105 is described by the bar code 145.

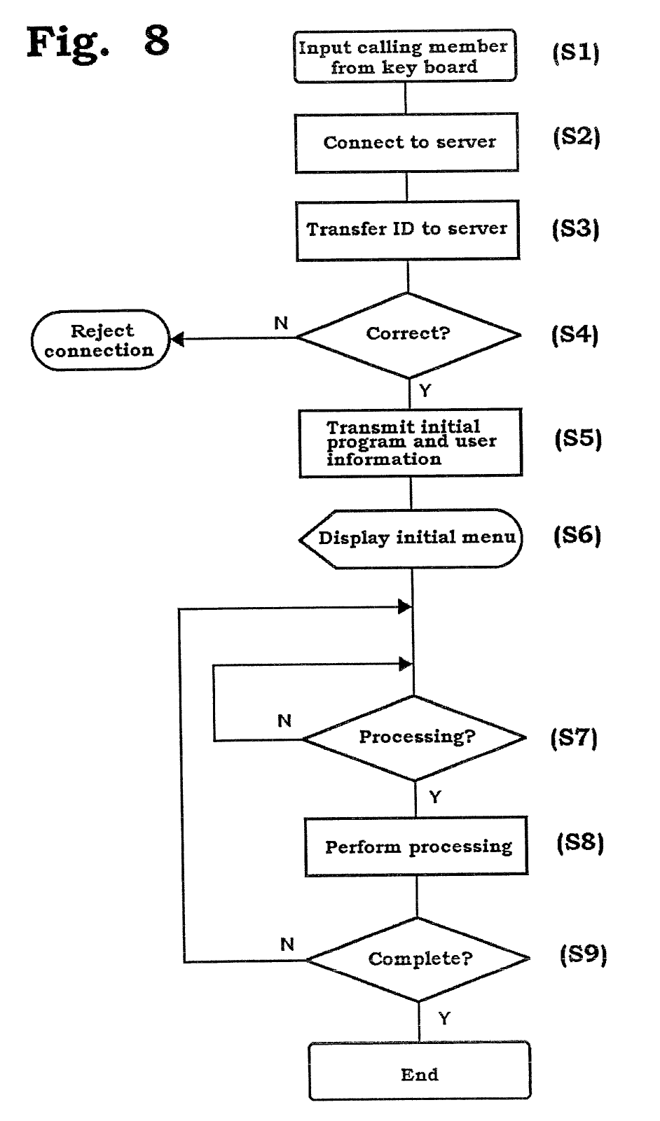

FIG. 8 is a flow chart showing contents of the program, which is written and described in the ROM 148 of the NC 102. The program is activated by the access information to be inputted from the keyboard. Then, the ISDN communication network 101a and a calling number of the server 103, which is connected to the NC 102, are inputted by the keyboard (S 1). The NC 102 connects the server 103 (S 2), which is called in S1 through the ISDN communication network 101a, which is connected to the NC 102 to complete the connection. Then, the NC 102 inputs the ID, which is specific for the user by the keyboard to transfer the ID to the server 103 (S 3).

The server 103 judges whether the transferred ID is correct or not (S 4). In the case that it is correct, user interface information for the user and an application program are transferred to the NC 102 from the server 103. On the basis of the corresponding user interface information and the application program, information such as an initial meal menu or the like is displayed on the monitor 149 (S6) and it is judged whether the NC 102 should be activated to carry out various processing (S 7) and perform the processing on the basis of the initial meal menu displayed on the monitor 149 in S6 (S 8).

The details with respect to the processing will be described later. For example, the processing includes inputting the ID, the calling number of the server 103 and the searching information of the data base 105 in the health controlling terminal 104, which is brought with the applied person 107. In order to complete the NC 102, a completion notice to be inputted from the inputting device is judged (S 9). If it is judged that the NC 102 should not be completed, the processing returns to S 7. If it is judged that the NC 102 is completed, the operation of the NC 102 is completed. Alternatively, any one of NC 102 is available by inputting the calling information of the server 103 and the ID, which is specific for the user.

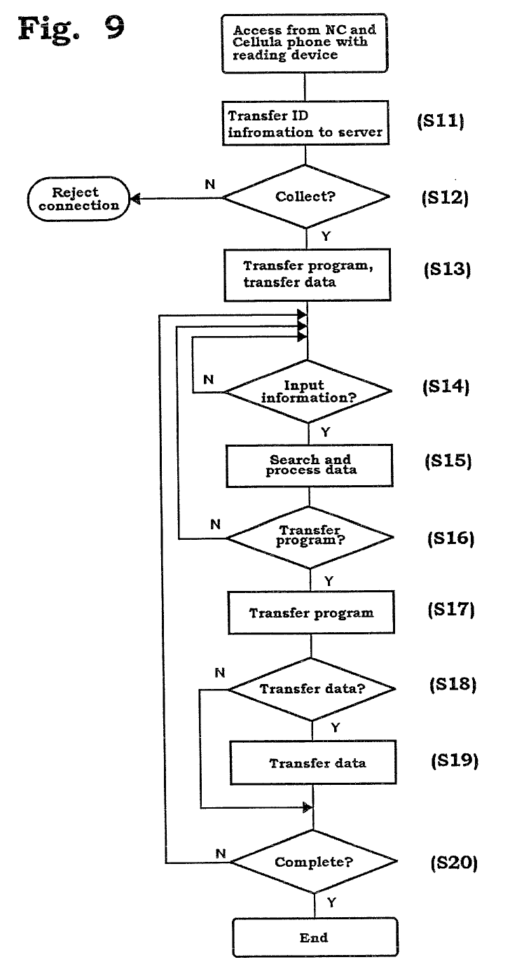

FIG. 9 is a flow chart showing the operation of the server 103. The server 103 is connected to a device which transmits the calling information by this calling information, which is transmitted from the NC 102 and the health controlling terminal 104 to be capable of being accessed. A processing program of the server 103 is activated by the access information from the NC 102 and the health controlling terminal 104.

At first, the operation in the case that the NS 102 is activated by the access information will be explained below. The ID is transferred from the NC 102 to the server 103 (S 11). Then, the server 103 judges whether the ID is correct or not (S 12). If it is not correct, the server 103 rejects connection and if it is correct, the server 103 transfers the user interface information of the user and the program to be effected at first to the corresponding NC 102 (S 13).

Then, judging whether the information is inputted from the NC 102 or not (S 14), it the result is positive, the inputted data is analyzed and processed (S 15). The detailed explanation with respect to the processing will be described later. For example, in the case that the data associated with a blood test or the like of the applied person 107 is inputted from the medical institution 108, the medical institution 108 adds this data to the past data of the applied person 107, makes a graph and displays it on the monitor 149. Then, the data of the graph is stored in the data base 105.

As a result in S15, the program is judged whether it is necessary to be transferred or not (S 16). If it is necessary, a required program is transferred to the NC 102 (S 17). As a result in S15, the data is judged whether it is necessary to be transferred or not (S 18). If it is necessary, the data is transferred to the NC 102 (S 19). The data to be transmitted to the above-described NC 102 comprises data which is processed in S 15, i.e., data of a graph of the numerical values of the blood test of the applied person 107. The program to be transferred comprises a program to be indicated in the graph made form the numerical values of the blood test of the applied person 107.

Alternatively, in the case that the searching information is transferred from the NC 102 to the server 103, the data base 105 is searched on the basis of the corresponding searching information and the corresponding data is read out to be transferred to the NC 102, so that it becomes possible to search the data base 105. Further, in the case of completing the server 103, the completion notice from the NC 102 or the server 103 is judged (S 20). If it is judged that the server 103 should not be completed, the processing returns to S 14. If it is judged that the server 103 should be completed, the operation of the server 103 is completed.

Next, the operation such that the server 103 is accessed from the health controlling terminal 104 will be explained. The health controlling terminal 104 transfers the ID to the server 103 (S 11) and the server 103 judges whether the ID is correct or not (S 12). If it is not correct, the server 103 rejects the connection. If it is correct, the server 103 transfers the user interface information and the program to be initially executed to the applied person 107 with respect to the health controlling terminal 104. At the same time, the program displaying data, such as a graph of the energy quantity for each nutritional element, which can be ingested by the applied person 107 in a day, for example, the program displaying a radar chart is transferred to the health controlling terminal 104 (S 13).

The server 103 judges whether the searching information is inputted from the health controlling terminal 104 or not (S 14). If the result is positive, the reading device 121 of the health controlling terminal 14 reads the characters of the figures described in the information source medium such as a food and drink having a searching function 115, a meal menu having a searching function 114 and the system notebook 112, for example, the bar code 145 to obtain the searching information. Then, the obtained searching information is transferred to the server 103, the data base 105 is searched by using the corresponding searching information (S 15) and the corresponding data is read to be transferred to the health controlling terminal 104. At the same time, the data is analyzed and processed (S 15).

Next, the processing of the data will be explained. For example, if the bar code 145 described in the cheeseburger set in the meal menu having a searching function 114 is read by the reading device 121, which is attached to the health controlling terminal 104 to obtain the information and the corresponding information is processed by a processing device 123, namely, the searching information of the data base 105 is inputted, searching the data base 105 and reading the data stored therein, i.e., the energy quantity for each nutritional element of the cheeseburger set, the corresponding energy quantity for each nutritional element of the cheeseburger set is added to the data of the graph of the energy quantity for each nutritional element, which is stored in the data base 105 and can be ingested by the applied person 107 in a day to be stored.

As a result of the processing in S 15, it is judged whether the program is necessary to be transferred or not (S 16). If it is necessary, a required program is transferred to the health controlling terminal 104 (S 17). Further, as a result of the processing in S 15, it is judged whether the data is necessary to be transferred or not (S 18). If it is necessary, a required data is transferred to the health controlling terminal 104 (S 19). The above-described data to be transferred to the health controlling terminal 4 comprises the data which is processed in S 15, namely, the data obtained by the applied user 107 in such a manner that the data of the energy quantity for each nutritional element of the cheeseburger set is added to the data of the graph of the energy quantity for each nutritional element, which can be ingested by the applied person 107 in a day. Further, the program to be transferred comprises a program to display the created graph.

In the case that the searching information is inputted from the health controlling terminal 104, the data base 105 is searched on the basis of the searching information and the corresponding data is read to be transferred to the health controlling terminal 104. At the same time, the data base 105 is capable of being searched. In order to complete the server 103, the completion notice from the health controlling terminal 104, or the server 103 is judged (S 20). If it is judged that the server should not be completed, the processing returns to S 14. If it is judged that the server should be completed, the operation of the server 103 is completed.

As described above, this health controlling terminal 104, which is brought with the applied person 107, searches the data base 105 through the server 103, which is installed in the information service company 106 on the basis of the searching information, which is obtained by reading the characters of the figures described in the information source medium such as a food and drink having a searching function 115, a meal menu having a searching function 114 and the system notebook 112, for example, the bar code 145 by using the reading device 121. As a result, it is possible to obtain the information associated with the meal including the above-described energy quantity for each nutritional element and the appropriate ingested meal quantity, so that the meal is capable of being controlled by oneself considering the corresponding information.

Next, service contents of the health controlling terminal 104 and the NC 102 will be explained, to be processed by the server 103.

Individual Information Inspection Service (NS 102)

An instructor associated with self-control of a meal, who the applied person 107 sets up in advance and is registered in the information service company 106, for example, a doctor in charge or a dietitian in the medical institution 108, a counselor or a dietitian in the sports gym and the aesthetic salon 109 or the like are provided with a specific ID from the information service company 106, respectively. Then, they input the corresponding ID in the NC 102 to inspect the information associated with the meal, the ecological information such as the blood sugar level and the body weight or the like and the individual information of the applied person 107.

(B) Office Work Service (NC 102)

In the small medical institution 108, the sports gym and the aesthetic salon 109 or the like, it is possible to access from the NC 102 to the server 103, to download various programs such as client management and accounting control or the like and to input the information in real time for processing it. At the same time, the processed data is stored in the data base 105 so that the processed data is capable of being accessed according to need.

(C) Accommodation and Related Product Inspection Service (health controlling terminal 104)

The guidance and availability of the service institutions such as public accommodations and nongovernmental accommodations, handling commodities in the restaurant 110 and the delicatessen shop 111 or the like and the information such as a product guidance, particularly, of a low calorie food and a low salt food used in the diet therapy are stored in the data base. As a result, the applied person 107 is capable of searching necessary information by using the searching information, which is obtained by reading the bar cord 145 described in the information source medium such as the system notebook 112 or the like with the health controlling terminal 104.

(D) Individual Information Storage Service (health controlling terminal 104)

Defining the health controlling terminal 104 as a communication medium, the applied person 107 may be able to store various information, for example, the address book or the like in a specific address, which is set in the data base 105 of the information service company 106 in advance and access the information according to need.

(E) Diet Therapy Controlling Service (health controlling terminal 104)

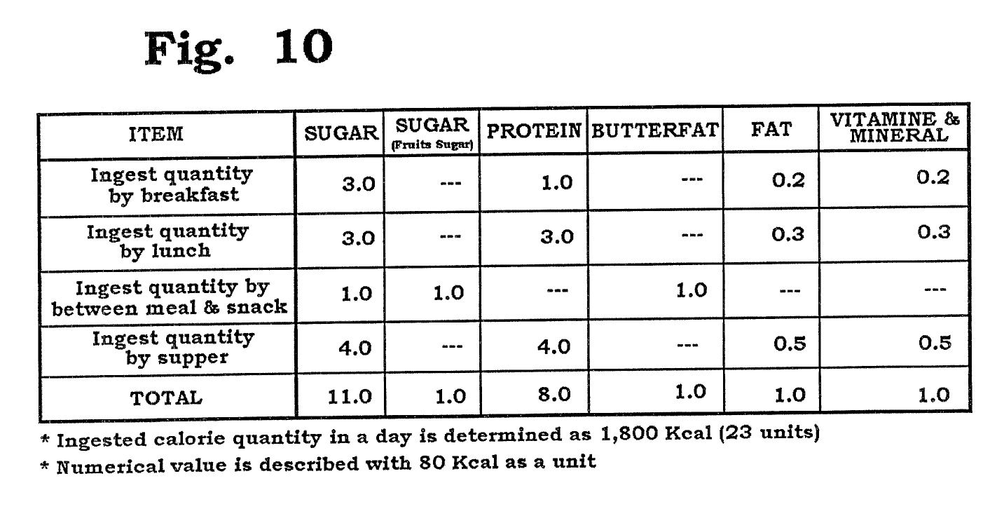

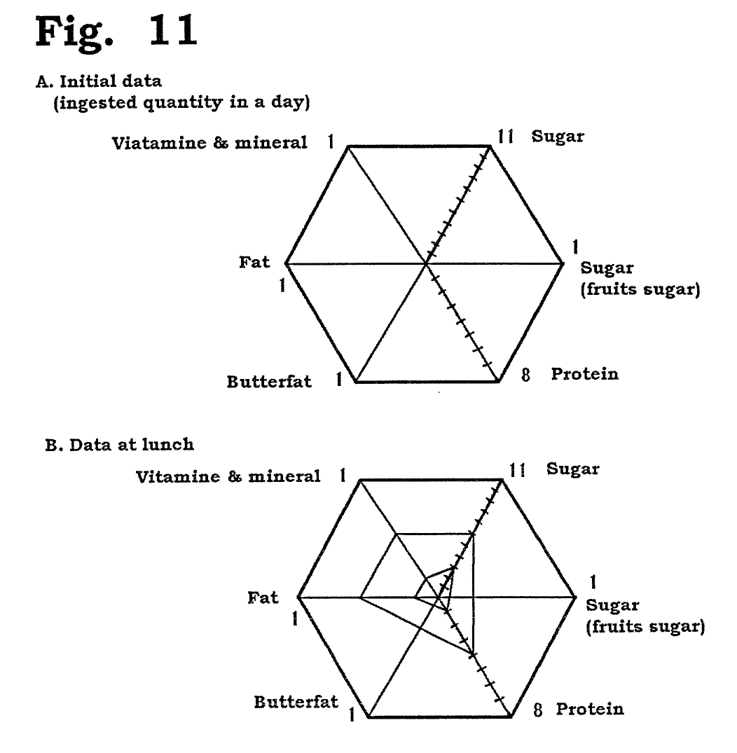

In the case that the applied person 107 is a diabetic patient and the meal quantity and the physical exercise quantity in a day are determined in advance, the ingested energy for each nutritional element is determined by the medical institute 108 as shown in FIG. 10 and the corresponding data is graphed out in the health controlling terminal 104 by using a radar chart or the like so that the patient can confirm easily as shown in FIG. 11. The applied person 107 selects and ingests the food and drink such as every meal and a between-meal snack or the like on the basis of the data, which is indicated by this radar chart.

In order to select the food and drink to be ingested, for example, in the restaurant 110, the applied person 107 selects the food and drink to be ingested from the foods and drinks, which are described in the information source medium such as the food and drink having the searching function 115 or the system notebook 112. Then, the applied person 107 reads the characters or figures, which are described in the selected food and drink, for example, the bar code 145 by the reading device 121 of the health controlling terminal 104. On the basis of the searching information obtained in this way, searching the data base 105 to read the corresponding information, analyzing and processing the read information by the server 103, the corresponding information is indicated in the radar chart (FIG. 11) displayed on the health controlling terminal 4 as a graph-out information.

In the case that the ingested quantity of the nutritional elements in the food and drink excesses any one of the ingested quantity for each nutritional element in a day, which is indicated in the radar chart (FIG. 11) in advance, selection of the food and drink is stopped and a new food and drink are searched to be selected, such that it does not excess the range of the ingested quantity for each nutritional element in a day, which is indicated in the radar chart (FIG. 11). Alternatively, it is possible to find the nutritional element, which is less ingested, in the ingested quantity for each nutritional element in a day so as to supplement this nutritional element. In this way, it becomes possible to take a well-balanced meal in the range of the ingested meal quantity determined by the medical institute 108.

All data and programs to be displayed in the above-described health controlling terminal 104 are stored in the data base 105. Alternatively, the time for measuring the blood sugar value, the body weight and the blood pressure and the time for giving insulin and an oral medicine or the like are notified and the executed time and measured values are stored in the data base 105. The data which is stored in the data base 105 is capable of being searched and read in such a way that the doctor in charge of the medical institution 108, who is selected by the applied person 107 in advance and registered in the information service company 106, accesses the server 103 through the NC 102.

For inputting the data in the NC 102, inputting devices such as a remote controller provided with a simple keyboard, a full keyboard, pen touch input using a touch board and a touch input of CRT or the like among the devices composing the present system may be used. Alternatively, the ID, the calling information and the searching information or the like to be inputted in the NC 102 may be written in an IC card, a magnetic card and an optical card or the like to be used by providing a reader/writer of respective cards in the NC 102 in addition to the above-described inputting devices.

In the above explanation, as the ecological detecting device, a method to input automatically the measured data of the blood sugar measuring instrument and the blood pressure measuring instrument is disclosed. However, measuring items may not limited to these items and all items such as the body weight and the body fat ratio, an electrocardiographic wave form and an analyzing result of urine or the like, which are used in the diet therapy for life habit diseases and the healthy slimming may be measured. Further, they may be manually measured by using conventional measuring instruments and the measured data may be inputted manually from the above-described inputting devices.

Additionally, for example, a bar code being a well-known method, which is described in the food and drink having a searching function 115, namely, many foods sold in the delicatessen shop 111 or the like and is used in POS system may be used as the characters or the figures, which are described in the system notebook 112 being a part of the meal self-control support system according to the present invention, a health control terminal operation manual 113 and the meal menu having a searching function 114 or the like in the information source medium described in the above explanation.

As described above, according to this health control support system, with respect to the system for supporting self-control of the meal, the applied person being infected with the life habit disease or being required to have the healthy slimming or the like is capable of inputting accurately the information without a complicate key operation but with a simple operation in such a manner that, various information, for example, the searching information or the like of the data base is patterned by the character or the figures such as the bar code or the like and recorded in the information source medium as the information medium associated with the food and drink, so that this record is read by the health control terminal.

Alternatively, according to this health control support system, a simple configuration composed of the health control terminal, the network computer, the server and the data base allows a high quality support service to be provided. The applied person uses the health control terminal, or the network computer in the medical institution, the sports gym and the aesthetic salon or the like to access the server of the information service company, respectively, so that storing specific information of the applied person, searching the storage information thereof and the information associated with the meal or the like and reading necessary information becomes possible.

As described above, according to the third aspect, this health controlling terminal 104 comprises reading means for reading a record, which is patterned in a predetermined format as searching information for searching an ingested energy of a food and drink in an information medium associated with the food and drink, decoding means for decoding the searching information from the read information of the reading means, transmitting means for transmitting a radio signal for transferring the decoded searching information to a predetermined device, receiving means for receiving a radio signal to be returned with respect to the transmitted radio signal as health control information of a person who brings the health control terminal with oneself associated with the ingested energy of the food and drink, which is searched by the searching information and informing means for informing the received health control information, which is received by the receiving means.

On this account, it is possible to obtain easily and accurately the ingested energy of the food and drink and the health control information of the person who brings the health controlling terminal with oneself associated to the ingestion of the food and drink.

Alternatively, as described in the ninth aspect, in the health control support system using this health controlling terminal 104, the control device is constructed in such a manner that it returns the energy information of the food and drink, which is searched by the searching information to be transmitted from the health control terminal 104, in the energy information of the food and drink, which are stored in the data base, as the health control information, which is necessary for the diet therapy and the healthy slimming of the person who brings the health control terminal with oneself and stores the ingested energy information of the person who brings the health control terminal with oneself.

On this account, it is not necessary for the applied person to conject the energy quantity of the food and drink and write it upon eating out and the ingested energy information is capable of being easily and accurately recorded in the data base 14 of the controlling apparatus. Therefore, taking the food and drink depending on the instruction from the controlling apparatus, a reliable effect with respect to the diet therapy and the healthy slimming can be expected.

Further, according to the above-described health control support system, not the energy information of the food and drink itself, but the searching information for searching the above energy information is recorded in the information medium associated with the food and drink, so that the large quantity of recording the pattern information of the information medium is not needed. Furthermore, also in the case of changing the energy information of the food and drink, the recording information is not required to be changed, but only the information of the data base may be changed. Only the information of the data base is capable of being changed speedy, so that the wrong energy information is not notified to the applied person.

In the above explanation, the health controlling terminal 104, which is provided with the reading device 121, and the health control support system by the use of the health controlling terminal 104 are explained. However, removable storage medium may be installed in a health controlling terminal so that it becomes possible to send and receive the information or the like, which is necessary for a function to measure a physical exercise quantity of the applied person and the health control not through the radio communication network but directly to and from other devices. In this way, if the function to measure the physical exercise quantity is installed in the health controlling terminal, the energy quantity ingested by the meal and the energy quantity lost by the physical exercise are capable of being controlled, so that more accurate health control is realized.

Next, a health controlling terminal having this function to measure a physical exercise quantity and a removable storage medium and a health control support system using a health controlling terminal will be explained below.

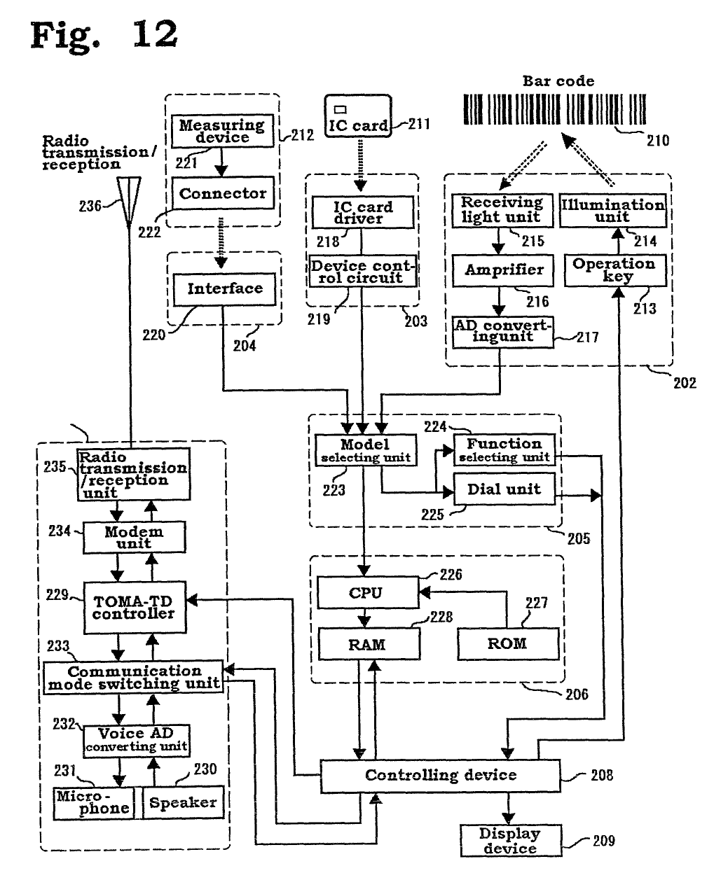

FIG. 12 is a block diagram showing a constitution of a portable health control terminal 201 having a function to measure a physical exercise quantity.

This health control terminal 201 is provided with a reading device 202 for reading the information, which is displayed by the characters and the patterns on the information medium associated with the above-described food and drink. Here, a bar code reader is explained in the case that the reading device 202 reads a bar code 210.

Alternatively, this health control terminal 201 is provided with a reader/writer 203 for reading and writing the information with respect to an IC card 211. This reader/writer 203 intends to send and receive the information to and from the ecological information measuring instruments for measuring the blood sugar value and the blood pressure or the like or other device including any network computer or the like ad this health control terminal 201 not through the communication.

An access device 204 intends to input and output the information of a physical exercise quantity measuring unit 212 to be described later or other device in and to this health control terminal 201.

An information selecting device 205 selects the information to be inputted from the bar code reader 202, the reader/writer 203 and the access device 204. Alternatively, the information selecting device 205 is provided with a manual inputting device for inputting various information such as information associated with setting function and a calling number of the health control terminal 201.

Further, a processing device 206 processes the information which is selected by the information selecting device 205 and the information to be transferred from other device such as a server or the like to store them. A communication device 207 intends to transfer processing information of the above mentioned processing device 206 to other device such as server or the like or perform a phone call with other communication device. A controlling device 208 controls respective devices of the health control terminal 201.

A display device 209 displays the information, which is inputted and outputted to and from the health control terminal 201 and the operational method thereof. A physical exercise quantity measuring unit 212 is brought with the applied person to measure the physical exercise quantity and record the result.

Next, the detail constitution of the above respective parts will be explained below.

An operational key 213 of a bar code reader 202 allows an illumination unit 214 of this bar code reader 202 to be illuminated and be possible to be read. The illumination unit 214 is composed of, for example, an LED array.

A receiving light unit 215 intends to receive the reflection of the light, which is irradiated on the bar code 210 by the illumination unit 214. The receiving light unit 215 is composed of, for example, a CCD array.

In an output signal of the receiving light unit 215, the strength levels of the reflection are changed in two levels, comprising the case such that the light emitted from the illumination unit 214 is irradiated on a bar part (a black part) of the bar code 210 and the strength of the reflection is low and the case such that the light emitted from the illumination unit 214 is irradiated on a space part (a white part) of the bar code 210 and the strength of the reflection is high.

The output signal of the receiving light unit 215 is amplified by an amplifier 216 to be inputted in an AD converting unit 217 and be converted into a digital signal.

Alternatively, the reader/writer 203 is composed of an IC card driver 218 and a driver control circuit 219. An access device 204 is composed of an interface circuit 220.

The physical exercise quantity measuring unit 212 is composed of a physical exercise quantity measuring sensor, for example, a three dimension accelerated velocity sensor, a physical exercise quantity measuring device 221 composed of a processing device for processing the information which is detected by the three dimension accelerated velocity sensor and storing it and a connector 222 as an access device, which enables to access the information by coupling the physical exercise quantity measuring unit 212 to a device at a main body side.

The information selecting device 205 selects an information mode. For example, the information selecting device 205 selects a mode selecting unit 223 composing of a mode key 223-A and an executing key 223-B to execute the selected mode and the effect and the function thereof. For example, the information selecting device 205 is composed of a function selecting unit 224 such as a power source key 224-A, a calling key 224-B and a phone book calling key 224-C or the like and a dial unit 225 for inputting the characters, alphanumeric and symbols such as a calling number and a phone book function or the like.

The processing device 206 is composed of a CPU 226 for processing the information to be inputted from the above-described respective devices, a ROM 227 for storing the operational programs of the CPU 226 and a RAM 228 for storing respective information which is processed by the CPU 226 and various information to be inputted and outputted to and from the health control terminal 201.

A TDMA-TDD controller 229 of the communication device 207 intends to control a time divisional multi dimension connection system (TDMA system), for example, time divisional bi-directional communication (TDD) for transmitting and receiving the signal with the same frequency.

A speaker 230 is used for listening the voice in the phone call and a microphone 231 is used for inputting the voice. A voice A/D converting unit 232 converts an analog voice signal to be inputted from the microphone 231 into a digital signal and outputs the digital signal to a communication mode switching unit 233. On the other hand, the voice A/D converting unit 232 converts a digital signal to be inputted from the communication mode switching unit 233 into an analog voice signal and outputs the analog voice signal to the speaker 230.

The communication mode switching unit 233 selects whether the telephone call is an information communication or not. A modem unit 234 modulates a digital signal to be outputted into a signal for communication and outputs it to a radio transmission and reception unit 235. Then, the modem unit 234 demodulates the signal for communication, which is received by the radio transmission and reception unit 235, into a digital signal to output it to the communication mode switching unit 233. The radio transmission and reception unit 235 transmits and receives the signal for communication through an antenna for transmission and reception 236.

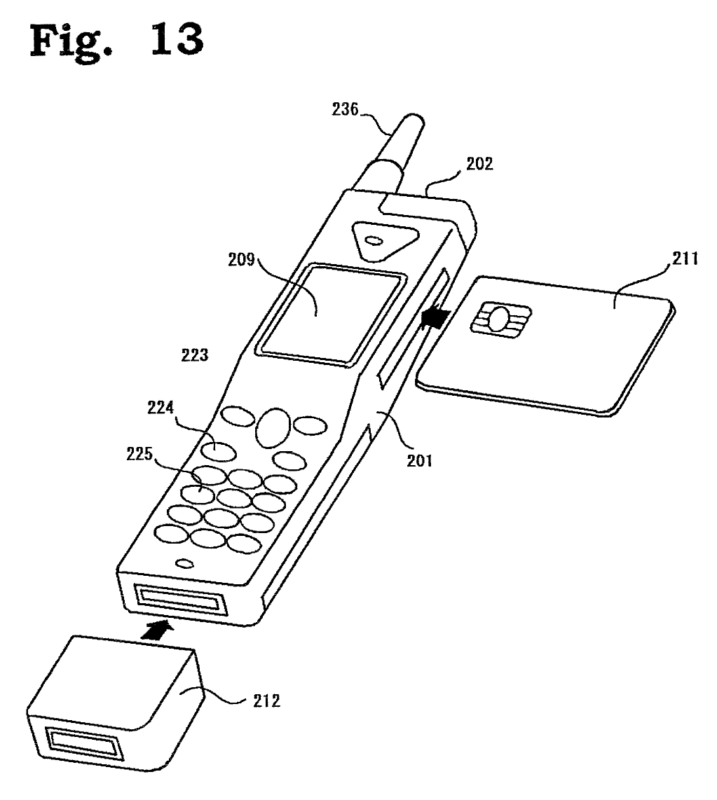

The health control terminal 201 constructed as described above has a main body, of which appearance is the same as that of a cellular phone of the main body, for example, as shown in FIG. 13. An upper end of the health control terminal 201 is provided with a bar code reader 202 and the antenna for transmission and reception 236. A front end thereof is provided with a display device 209 and a manual inputting device of the information selecting device 205, for example, the mode key 223-A of the mode selecting unit 223, the power source key 224-A of the function selecting unit 224 and the dial key such as the characters and alphanumeric of the dial unit 225 in the inputting devices using the key operation. A side end thereof is provided with the reader/writer 203 for the IC card 211. Alternatively, the physical exercise quantity measuring unit 212 is movably provided on a lower end of the health control terminal 201 through a connector.

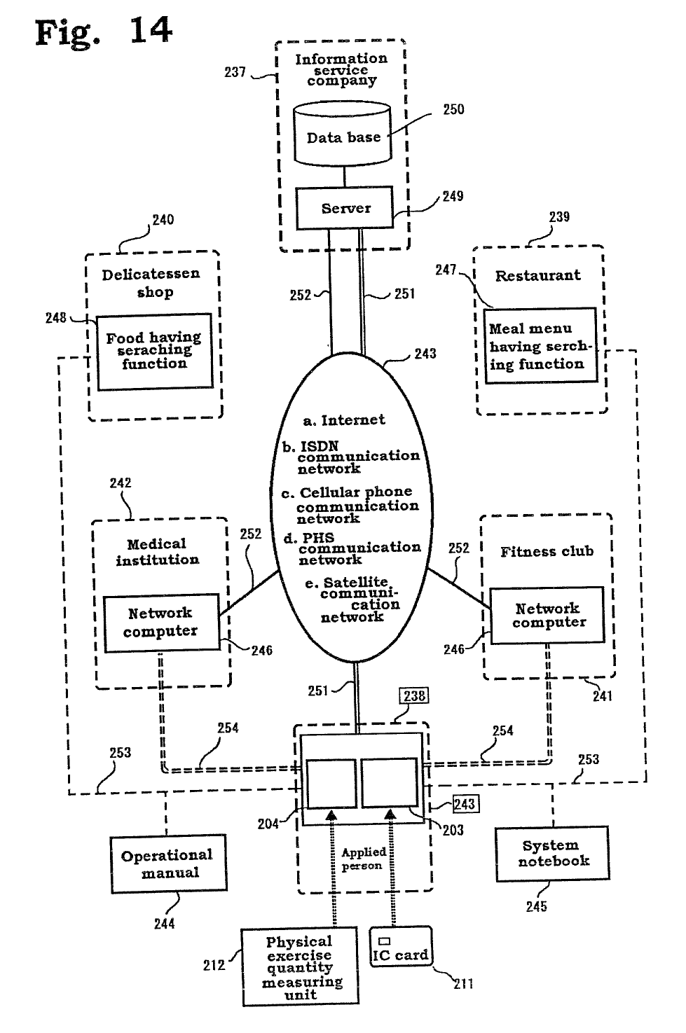

FIG. 14 shows a whole constitution of a health control support system for supporting the information control with respect to the physical exercise and the diet therapy for the life habit disease and the health by using the health control terminal 201 constructed as described above.

In FIG. 14, the information service company 237 constructs this health control system and supports the health control of the applied person 238 who brings the health control terminal 201 with oneself.

This health control support system is constructed by the information service company 237, a catering establishment 239 for cooking a meal and serving it such as a restaurant or the like, a delicatessen shop 240 for selling the food an drink, a fitness club 241 for instructing self-control of the health or the like such as a sport gym or the like and a medical institution 242 for curing the life habit disease or the like.

The health control terminal 201, the information service company 237, the fitness club 241 and the medical institution 242 are connected with each other through a communication network 243 (for example, an internet 243-a, an ISDN 243-b and a cellular phone communication network 243-c, a PHS communication network 243-d and a communication satellite communication network 243-e or the like).

Alternatively, an operational manual 244 of the health control terminal 201 includes a page in which the information to be inputted are described in order of inputting by the bar code 210 in replacement of complicate input operations which is required for inputting large quantity of information such as information to be inputted in the communication device 207, for example, a melody used as a receiving ring or the like.

The energy quantity for each nutritional element included in each food and drink of a meal menu is submitted in advance from the catering establishment 239 or the like. The numeric value of the above-described energy quantity for each nutritional element or the searching information for searching the energy quantity for each nutritional element to be stored in the data base installed in the information service company 237 is described by the bar code 210 on a system notebook 245.

The fitness club 241 and the medical institution 242 are provided with the network 246.

In the catering establishment such as a restaurant or the like, a meal menu 247 is provided. In this meal menu 247, the numeric value of the energy quantity for each nutritional element included in the food and drink or the searching information for searching the data base, in which the above-described energy quantity for each nutritional element is stored, is described by the bar code 210. Also, on a package or the like of the food and drink, which is sold in the delicatessen shop 240, the bar code 210 describing the searching information of the data base is displayed as same as above.

A server 249 and a data base 250 are provided in the information service company 237. A radio communication circuit 251 includes the cellular phone communication network 243-c, the PHS communication network 243-d and the communication satellite communication network 243-e or the like. A communication circuit 252 connects the server 249 with the network 246. For example, the communication circuit 252 comprises an ISDN communication circuit.

In FIG. 14, a reference numeral 253 denotes a working conducting wire for reading the bar code 210 described in the meal menu having a searching function 247, which is installed in the restaurant 239 and the bar code 210 described in a package or the like of a processed food, which is purchased in the delicatessen shop 240 by using the bar code reader 202. A reference numeral 254 denotes a working conducting wire for inputting basic information such as a basic ingested quantity of a meal or the like when the applied person 238 brings the health control terminal 201 to the fitness club 241 and the medical institution 242 or the like.

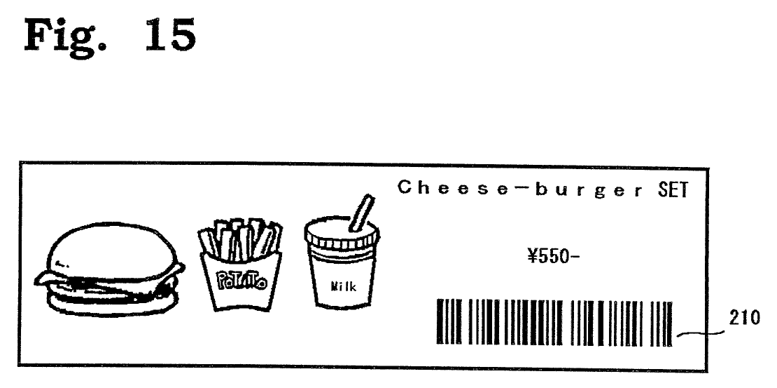

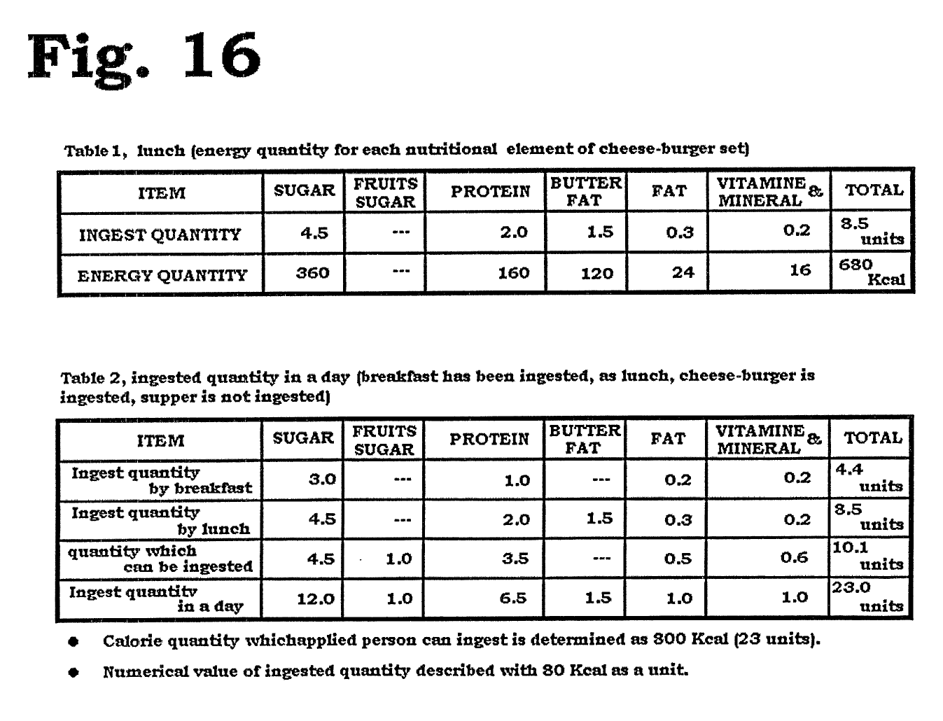

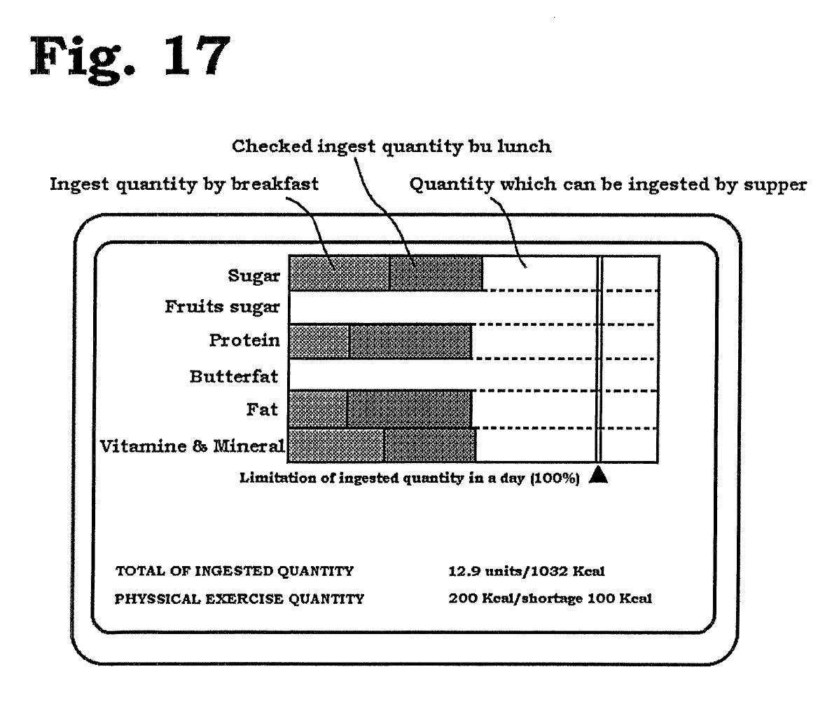

FIG. 15 is a view showing an example which is described in the meal menu having a searching function 247, which is installed in the restaurant 239, for example, a cheeseburger set. In FIG. 15, pictures of a cheeseburger, a fried potato and milk, an item name, a price and a bar code 210 are described. FIG. 16 shows an energy quantity for each nutritional element included in the above cheeseburger set and the energy quantity for each nutritional element, which can be ingested by the applied person 238 in a day by each meal. FIG. 17 is one example of a graph, in which the energy quantity obtained from a breakfast ingested by the applied person 238 and the energy quantity obtained by reading the bar code 210, which is described in the meal menu having a searching function 247, by using the bar code reader 202 of the health control terminal 201, upon ingesting the above cheeseburger set as a lunch are displayed by the display device 209.

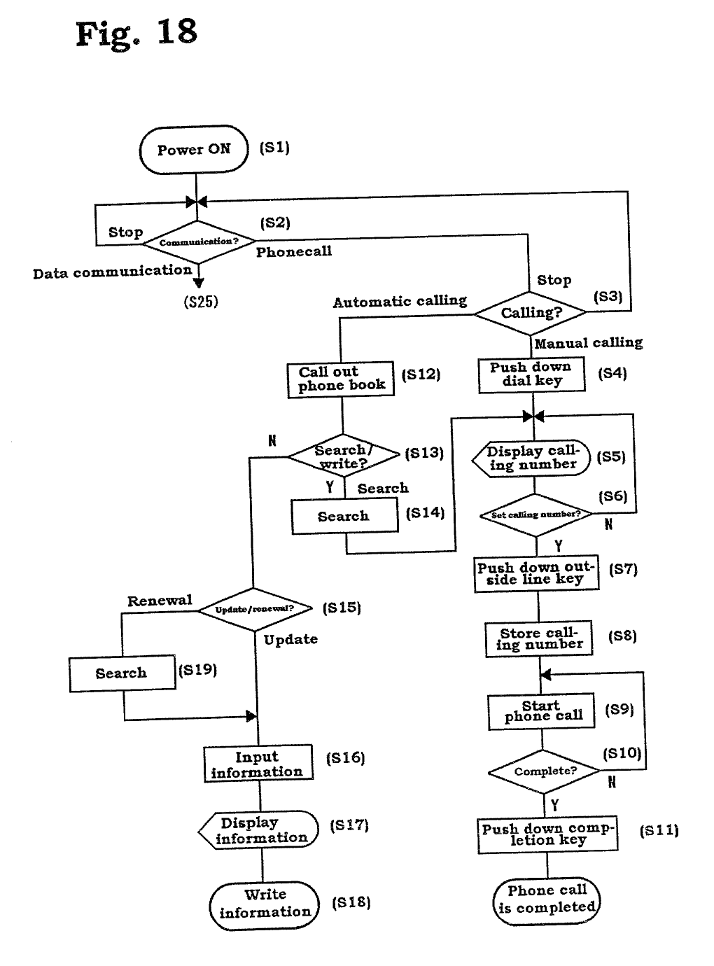

FIG. 18 is a flow chart for showing a normal operation with respect to the health control terminal 201. With reference to the present flow chart, the operation of the phone call mode with respect to the health control terminal 201 will be explained below.

At first, by pushing down the power source key 224-A for a predetermined time period, for example, one second, a power source turns ON (S 1) and the health control terminal 201 turns to a communication selection mode (S 2) for selecting a data communication or a phone call. In this situation, normally, the health control terminal 201 is in a phone call mode. By pushing down the executing key 223-B, the phone call mode turns to a calling method selection mode (S 3). Further, the mode key 223-A is pushed down several times to select a manual calling and the executing key 223-B is pushed down, so that the manual calling turns to an execution state.

Then, pushing down numeric keys in the dial unit 225 several times to select a calling number (S 4), the selected calling number is displayed on the display device 209 (S 5) and it is judged whether the number is correct or not (S 6). If the number is correct, pushing down the calling key 224-B several times in the function selecting unit 224 (S 7), the calling number is stored (S 8) and the health control terminal 201 is connected to the communication device with respect to the corresponding calling number, so that the health control terminal 201 turns to a phone call state (S 9). In order to complete the phone call (S 10), the calling key 224-B is pushed down again (S 11).

Then, an automatically calling will be explained below. In the calling method selection mode, which is selected in step 103, pushing down the mode key 223-A several times, the automatically calling is selected and pushing down the executing key 223-B, the automatically calling turns to the execution state. Further, pushing down the phone book calling key 224-C of the function selecting unit 224, the phone book is called out (S 12). In this situation, normally, the health control terminal 201 is in a phone book searching mode (S 13). Pushing down the mode key 223-A in succession and scrolling the phone book, the corresponding calling number is selected (S 14) from the calling numbers, which are displayed on the display device 209 (S 5). Then, it is judged whether the corresponding calling number should be updated or executed (S 6). In the case of execution, pushing down the calling key 224-B (S 7), the calling number is stored in the RAM 228 (S 8). At the same time, the health control terminal 201 is connected to the communication device with respect to the corresponding calling number, so that the health control terminal 201 turns to a phone call state.

Next, a phone book function will be explained below. In the calling method selection mode (S 3), pushing down the mode key 223-A several times, the automatically calling is selected and pushing down the executing key 223-B, the automatically calling turns to the execution state. Further, pushing down the phone book calling key 224-C of the function selecting unit 224 for a predetermined time period, for example, one second, the phone book is called out (S 12). In this situation, normally, the health control terminal 201 is in a phone book searching mode. Pushing down the mode key 223-A, selecting a information writing mode (S 13), pushing down the executing key 223-B several times, selecting newly writing the information (S 15) and freely using the inputting device in the dial unit 225, for example, inputting keys such as the alphanumeric and the characters or the like and a pen touch input or the like, the information to be newly written is inputted (S 16).

In the case that update is selected in S 15, pushing down the mode key 223-A in succession, scrolling and selecting the corresponding calling number from the calling numbers displayed on the display device 209 (S 19), the information is rewritten by the inputting device of the dial unit 225 to be inputted (S 16). New and update information to be inputted in S 16 is on the display device 209 (S 17). Judging whether the information is correct or not, if it is correct, pushing down the executing key 223-B, the rewritten information is written and stored in the RAM 228 (S 18).

Alternatively, a compact and light cellular phone allows a conventional information inputting device, for example, the inputting keys such as the characters, alphanumeric and symbols and the operational keys to be smaller. In the pen touch input, the display area becomes smaller and the operation thereof becomes complicate. Therefore, it becomes difficult for aged person to input multifunctional information. According to the health control terminal 201, it is possible to describe in advance the information to be inputted in S 115, for example, a personal name, a geographic name, a character, alphanumeric, dialing code and a melody of a receiving ring selection function or the like in the information source medium such as the operation manual 244 and the system notebook 245 or the like in order of inputting the information by the bar code 210. Further, it is also possible to read the above-described information by the bar code reader 202 and automatically input them (S 16).

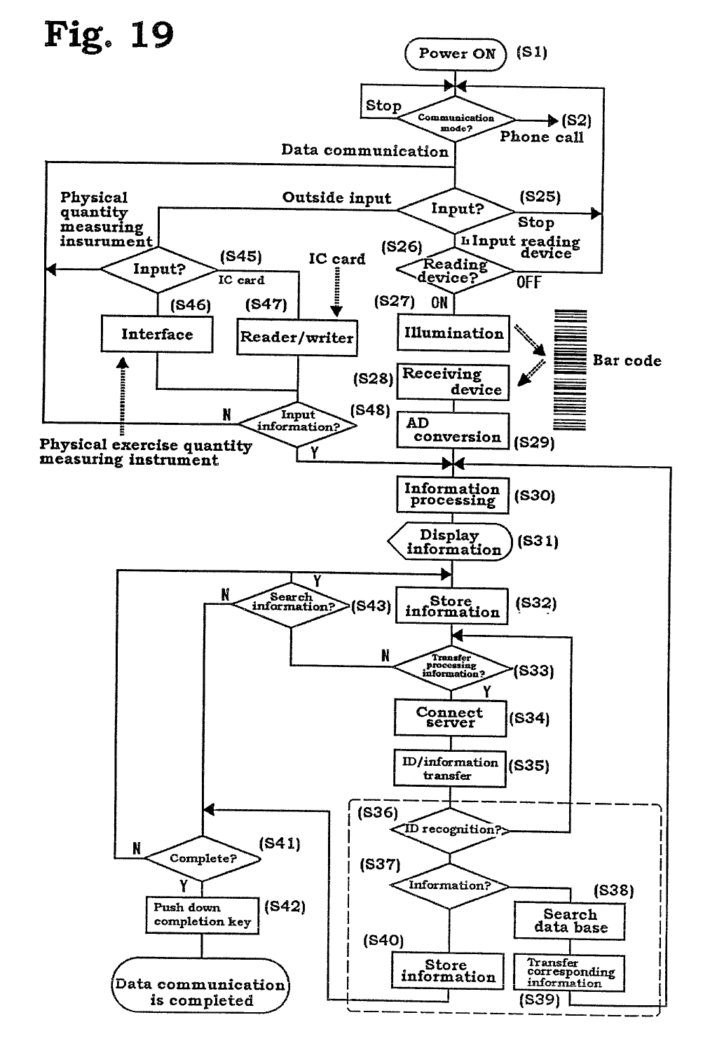

FIG. 19 is a flow chart showing the operation of the data communication in the health control terminal 201. With reference to the present flow chart, the effect of a data communication mode of the health control terminal 201 will be explained below.

At first, by pushing down the power source key 224-A for a predetermined time period, for example, one second (S 1), the power source turns ON and the health control terminal 201 turns to the communication selection mode (S 2) for selecting a data communication or a phone call. Then, pushing down the mode key 223-A several times, selecting the data communication mode and pushing down the executing key 223-B, the health control terminal 201 turns to an information selection mode for selecting input from the reading device 202 and the IC card 211 or other devices such as the physical exercise quantity measuring unit 212 (S 25).

In the information selection mode, the processing of the information to be inputted from the reading device 202 will be explained below. Pushing down the mode key 223-A several times, selecting the input of the reading device and pushing down the executing key 223-B, the reading device turns to the execution state. Then, the operational key 213 is pushed down in succession (S 26). On this account, irradiating the light of the LRD array 214, which illuminates in succession during the operational key 213 is pushed down on the bar code 210 (S 27), a signal which is outputted by receiving the reflection of the above light by the CCD array 215 (S 28), i.e., the analog signal which is strong in a space (white) portion and is weak in a bar (black) space, is amplified in the amplifier 216 to be converted into the digital signal in the AD converting unit 217 (S 29).

The digital signal, which is converted in the AD converting unit 217, is inputted into the processing device 206 to be processed (S 30). Taking, for example, the cheeseburger set in FIG. 15 in the food and drink as an example, the processing information of the above digital signal will be explained below. The information to be processed in step S 30 is displayed by the meal menu having a searching function 247 in the restaurant 239 or the like or the bar code 210 described in the system notebook 245 together with the cheeseburger set. The content of this information is the energy quantity for each nutritional element included in the cheeseburger set in FIG. 16, namely, a numerical value obtained by converting the calorie quantity in units of 80 kilo calories.

The information to be processed in the above processing device 206 is processed to be a graph out information in which the energy quantity for each nutritional element, which can be ingested in a day by the applied person 238, in various basic information to be inputted in the health control terminal 201 in advance in the fitness club 214, or the medical institution 242, is determined as 100%. The processed information is displayed by the display device 209 (S 31), for example, as a graph shown in FIG. 17 to be stored in the RAM 228 (S 32). It is judged whether this graph out information should be transferred to the data base 250 of the information service company 237 to be stored or not (S 33). If it should be stored, pushing down the calling key 224-B, the calling information in the above basic information allows the health control terminal 201 to be connected (S 34) to the server 249 installed in the information service company 237.

As the information to be transferred to the connected server 249, the ID of the applied person 238, the address of the data base 250 and the above mentioned processing information to be stored in the above basic information, namely, the information stored in S 32 are transferred (S 35). The above server 249 judges whether the transferred ID of the applied person 238 is correct or not (S 36). If it is correct, it is judged whether the transferred process information should be the storage information or the searching information (S 37). The above transferred processed information, i.e., the graph out information is recognized as the storage information and is stored in the corresponding address in the data base 250 (S 40). When storage is completed, it is judged whether the communication should be completed or not (S 41). If it should be completed, the calling key 224-B (S 42) is pushed down to complete the communication.

Then, taking, for example, the food and drink 248 to be sold in the delicatessen shop 240, for example, a cup noodle as an example of the processing information to be inputted in the processing device 206 and processed (S 30) will be explained below. The information with respect to the energy quantity for each nutritional element included in the cup noodle is provided in advance by a manufacturer of the cup noodle. This provided information has a segment information which is displayed by the bar code 210 on the container of the cup noodle as an address and is accumulated and stored together with the energy quantity for each nutritional element included in various foods and drinks in the data base 250, which is constructed in the information service company 237.

In order to search the information which is stored in the above-described data base 250, reading the bar code 210 which is displayed on the above mentioned cup noodle, then, the read information is processed in S 30 to be displayed on the display device 209 and stored in the RAM 228 (S 32).

Then, it is judged whether the searching information, which is processed by the above mentioned processing device 206, should be transferred to the server 247 of the information service company 237 or not (S 33). In the case of transferring the searching information, pushing down the calling key 224-B, the health control terminal 201 is connected to the server 249 (S 34), which is installed in the information service company 237 by the calling information in the above-described basic information.

In the above-described basic information, the above-described searching information such as the ID of the applied person 238 and the address of the data base 250 are transferred to the connected server 249 (S 35). At first, the above server 249 judges whether the transferred ID of the applied person 238 is correct or not (S 36). If it is correct, it is judged whether the transferred information should be the storage information or the searching information (S 37). The above transferred process information searches the information, which is recognized as the searching information and is stored in the corresponding address in the data base 250, i.e., the energy quantity for each nutritional element included in the above-described cup noodle (S 38) to be transferred to the health control terminal 201 (S 39).

The information, which is transferred in S 39 and processed (S 30), i.e., the energy quantity for each nutritional element included in the above-described cup noodle is processed to be a graph out information in which the energy quantity for each nutritional element, which can be ingested in a day by the applied person 238, in the basic information to be inputted in the health control terminal 201 in advance in the fitness club 245, or the medical institution 246, is determined as 100%. The processed information is displayed by the display device 209 (S 31) and is stored in the RAM 228 (S 32).

The applied person 238 judges whether the cup noodle should be ingested or not by using the graph out information, which is displayed on the display device 209. In the case that it should be ingested, the calling key 224-B (S 42) is pushed down to complete the communication (S 43). In the case that it should not be ingested, searching a new food and drink again by the operation in S 28 to S 39, then, the ingested food and drink is selected.

Next, in the information selection mode in S 25, outer input will be explained below. At first, in the outer input, the information to be inputted through the IC card 211 as a transmission medium includes the measured value of the ecological information measuring instrument provided with a reader/writer for the IC card 211, such as the body fat ratio, the body weight, the blood sugar level, the blood pressure level and a pulsation or the like and the physical exercise quantity of a physical exercise supporting machine such as an ergometer and a room running machine or the like. Alternatively, the information from the physical exercise quantity measuring unit 212 comprises the physical exercise quantity, which is measured by the physical exercise quantity measuring unit 212 being brought with the applied person 238, i.e., the energy quantity to be consumed by the daily life and running or the like.

These information are processed as follows. The input information is selected by the mode key 223-A (S 45). Then, in the case that the selected information is inputted from the physical exercise quantity measuring unit 212 (S 46), the selected information is inputted in the main body side device of the health control terminal 201 via the access device 204. In the case that the selected information is inputted from the IC card 211 (S 47), the selected information is inputted in the main body side device of the health control terminal 201 via the reader/writer 203. Then, it is checked whether the inputted information is the measuring information of the physical exercise quantity or the information to be inputted from the IC card 211 or not. Pushing down the executing key 223-B, the selected (S 48) information is inputted in the processing device 206 and is processed by the CPU 226 to be stored in the RAM 228.

The information stored in the RAM 228 is used to calculate the physical exercise quantity of the applied person 238 and the ingested meal quantity. At the same time, the information stored in the RAM 228 is stored in the data base 250 of the information service company 237 through the above-described operations of S 33 to S 39.

Thus, as shown in claim 4, the health control terminal 201 comprises physical exercise quantity measuring means for measuring the physical exercise quantity of a person who brings the health control terminal with oneself. The health control terminal 201 reads and decodes a record, which is patterned in a predetermined format as searching information for searching an ingested energy of a food and drink in an information medium associated with the food and drink, transmits the physical exercise quantity, which is measured by the searching information or the physical exercise quantity measuring means to a predetermined control device, receives and informs the health control information of the person who brings the health control terminal with oneself to be returned from the control device.

Therefore, it is possible to control the information associated with the energy, which the person who brings health control terminal 201 with oneself ingests from the food and drink and the energy, which the person who brings health control terminal 201 with oneself consumes by the physical exercise.

Alternatively, as shown in claim 9, the health control support system using this health control terminal 201, the control device is constructed in such a manner that it returns the ingested energy information of the food and drink, which is searched by the searching information to be transmitted from the health control terminal, in the energy information of the food and drink, which are stored in the data base, as the health control information, which is necessary for the diet therapy and the healthy slimming of the person who brings the health control terminal with oneself and stores the ingested energy information and the consumed energy information of the person who brings the health control terminal with oneself. Therefore, it is possible to give more delicate health control support to the person who brings the health control terminal 201 with oneself.

In the above-described health control support system, the energy information of the food and drink is not displayed on the information medium associated with the food and drink but the information for searching the above energy information is displayed on the information medium associated with the food. Therefore, the quantity of the displayed information can be small. Additionally, in the case of changing the energy information of the food and drink, only the information in the data base side may be changed without changing the displayed information. Since only the information in the data base side can be changed speedy, incorrect energy information cannot be notified to the applied person.

The above-described health control terminals 12, 104 and 201 are constructed in such a manner that a portable telephone having a phone call function becomes a main body. However, the health control terminal may be constructed in such a manner that the phone call function is omitted from the health control terminals 12, 104 and 201. In this case, the health control terminal is not required to have an outer shape suitable for the phone call, so that the outer shape, such that the display such as the meal menu or the like can be easily read and the energy information or the like to be displayed on the displaying unit can be easily seen, may be employed. At the same time, the health control terminal may be constructed in one main body without making the reading device and the physical exercise quantity measuring unit into detachable ones.

Alternatively, in the above-described health control support system, the energy information of the food and drink to be provided and sold by the catering establishment and the delicatessen shop is intensive in the data base in the information service company. However, the control device, constructed by the communication device for communicating with the health control terminal and the data base of the energy information of the food and drink to be provided and sold by the catering establishment and the delicatessen shop, may be installed in respective catering establishment and respective delicatessen shop. In this case, when the customer reads the indication printed on the package or the like of the food and drink and the meal menu, the read information is transmitted to the data base through the communication device in the catering establishment and the delicatessen shop. As a result, the information for showing the energy quantity for each nutritional element associated with the read information may be searched and be returned to the health control terminal.

Alternatively, the above-described respective health control terminals 12, 104 and 201 have a function of a cellular phone, by which a voice phone call is possible, and they access the control device by using the radio circuit of the cellular phone, so that it is not necessary to bring two terminals for the cellular phone and the health control terminal. Such a health control terminal is very convenient for the user.

Further, the above-described health control terminals 104 and 201 not only decode the information which is read by the reading device to transmit it to the control device, but also have a device for inputting and setting the information which is decoded by the decoding device as various parameters, which are necessary for the operation of the terminal. However, this function may also be installed in the above-described health control terminal 12. According to such a health control terminal having a device for inputting and setting the information which is decoded by the decoding device as various parameters, which are necessary for the operation of the terminal, it is not necessary to have a complicate key operation for setting the operation, but the operation thereof may be easily set by the reading device.

Additionally, the above-described health control terminal 201 reads and writes the information, which is necessary for the health control of the person who brings the health control terminal 201 with oneself, with respect to the IC card as an attachable/detachable storage medium so that the information of the IC card can be read by other device to be inputted and the information which can be written by other device can be inputted in the health control terminal. However, this storage medium may be other storage medium, if it is capable of holding not only the IC card but also the written information. Alternatively, the above-described health control terminals 12 and 104 may be provided with a device for reading and writing the information which is necessary for the health control of the person who brings the health control terminal 201 with oneself, with respect to this storage medium.

As explained above, the information medium associated with the food and drink according to the first aspect of the invention comprises an information medium associated with a food and drink, including the information medium such as a package or the like of a meal menu and the food and drink, wherein information showing an ingested energy of each food and drink is patterned in a predetermined format and recorded.

Therefore, the ingested energy information of the food and drink is capable of being accurately and easily obtained by using the reading device of the pattern suitable for this ingested energy information of the food and drink.

Alternatively, the health control terminal according to the second aspect of the invention comprises reading means for reading a record, which is patterned in a predetermined format as information showing an ingested energy of a food and drink in an information medium associated with the food and drink, decoding means for decoding the ingested energy of the food and drink from the read information of the reading means, transmitting means for transmitting a radio signal for transferring the energy information, which is decoded by the decoding means, to a predetermined device, receiving means for receiving a radio signal to be returned with respect to the radio signal, which is transmitted by the transmitting means, as health control information of a person who brings the health control terminal with oneself associated with the ingested energy of the food and drink and informing means for informing the health control information, which is received by the receiving means.

Therefore, without an inaccurate conjecture and a complicate calculation or the like, it is possible to obtain accurate ingested energy information with a simple operation for only reading the ingested energy of the food and drink from the information medium.

Alternatively, the health control terminal according to the third aspect of the invention comprises reading means for reading a record, which is patterned in a predetermined format as searching information for searching an ingested energy information of a food and drink in an information medium associated with the food and drink, decoding means for decoding the searching information from the read information of the reading means, transmitting means for transmitting a radio signal for transferring the searching information, which is decoded by the decoding means, to a predetermined device, receiving means for receiving a radio signal to be returned with respect to the radio signal, which is transmitted by the transmitting means, as health control information of a person who brings the health control terminal with oneself associated with the ingested energy of the food and drink, which is searched by the searching information and informing means for informing the received health control information, which is received by the receiving means.

Therefore, without an inaccurate conjecture and a complicate calculation or the like, it is possible to obtain the health control information associated with accurate ingested energy information with a simple operation for only reading the searching information of the ingested energy of the food and drink from the information medium.

The health control terminal according to the forth aspect of the invention comprises physical exercise quantity measuring means for measuring the physical exercise quantity of a person who brings the health control terminal with oneself, reading means for reading a record, which is patterned in a predetermined format as searching information for searching an ingested energy information of a food and drink in an information medium associated with the food and drink, decoding means for decoding the searching information from the read information of the reading means, transmitting means for transmitting a radio signal for transferring the physical exercise quantity, which is measured by the physical exercise quantity measuring means or the searching information, which is decoded by the decoding means, to a predetermined device, receiving means for receiving a radio signal to be returned with respect to the radio signal, which is transmitted by the transmitting means in order to transfer the searching information to a predetermined device, as health control information of a person who brings the health control terminal with oneself associated with the ingested energy of the food and drink, which is searched by the searching information and informing means for informing the received health control information, which is received by the receiving means.

Therefore, it is possible to know accurately the energy which the person who brings the health control terminal with oneself ingests from the food and drink and the energy which the person who brings the health control terminal with oneself consumes by the physical exercise, so that the health control can be performed more accurately.

Since the health control terminal according to the fifth aspect of the invention has a function of a cellular phone, by which a voice phone call is possible, and accesses the control device by using the radio transmission and reception means of the cellular phone. Accordingly, it is not necessary to bring two terminals for the cellular phone and the health control terminal, so that the terminal can be compact.

Since the health control terminal according to the sixth aspect of the invention has a device for inputting and setting the information which is decoded by the decoding device as various information, which are necessary for the operation of the terminal, a complicate key operation is not necessary and the information, which is necessary for the operation is capable of being set easily and accurately.

Since the health control terminal according to the seventh aspect of the invention has an attachable/detachable storage medium and a device for reading and writing the information, which is necessary for the health control of the above-described person who brings the health control terminal with oneself with oneself, with respect to the corresponding storage medium, the information of the storage medium can be read by other device to be inputted and the information which can be written by other device can be inputted in the health control terminal easily.

Alternatively, the health control support system according to the eighth aspect of the invention comprises a health control terminal to be brought with a person who requires a diet therapy and health slimming, a control device having a data base, in which the information associated with the health of each person who brings the health control terminals with oneself is stored and a network for enabling transmission and reception of the information between the health control terminal and the control device; wherein the health control terminal comprises reading means for reading a record, which is patterned in a predetermined format as information showing an ingested energy of a food and drink in an information medium associated with the food and drink, decoding means for decoding the ingested energy of the food and drink from the read information of the reading means, transmitting means for transmitting a radio signal for transferring the energy information, which is decoded by the decoding means, to the control device, receiving means for receiving a radio signal to be returned with respect to the radio signal, which is transmitted by the transmitting means, as health control information of a person who brings the health control terminal with oneself associated with the ingested energy of the food and drink and informing means for informing the health control information, which is received by the receiving means; wherein the control device is constructed in such a manner that it returns the health control information, which is necessary for the diet therapy and the health slimming of the person who brings the health control terminal with oneself, associated with the ingestion of the food and drink and stores the ingested energy information of the person who brings the health control terminal with oneself on the basis of the energy information to be transmitted from the health control terminal and the information of the person who brings the health control terminal with oneself, which is stored in the data base.

Therefore, it is not necessary for the applied person oneself to conject and write the energy of the food and drink and the ingested energy information is capable of being recorded accurately and easily in the data base of the control device, so that by taking the food and drink in accordance with the instruction from the control device, a reliable effect with respect to the diet therapy and the healthy slimming can be expected.

Additionally, the health control support system according to the ninth aspect of the invention comprises a health control terminal to be brought with a person who requires a diet therapy and health slimming, a control device having a data base, in which the information showing an ingested energy of a food and drink, which is provided by a catering establishment and the food and drink, which is sold by a delicatessen shop is stored in advance and a network for enabling transmission and reception of the information between the health control terminal and the control device; wherein the health control terminal comprises reading means for reading a record, which is patterned in a predetermined format as searching information for searching the ingested energy information of the food and drink in an information medium associated with the food and drink, decoding means for decoding the searching information from the read information of the reading means, transmitting means for transmitting a radio signal for transferring the searching information which is decoded by the decoding means, to the control device, receiving means for receiving a radio signal to be returned with respect to the radio signal, which is transmitted by the transmitting means, as health control information of a person who brings the health control terminal with oneself associated with the ingested energy of the food and drink, which is searched by the searching information and informing means for informing the health control information, which is received by the receiving means; wherein the control device is constructed in such a manner that it returns the ingested energy information of the food and drink, which is searched by the searching information to be transmitted from the health control terminal, in the energy information of the food and drink, which are stored in the data base, as the health control information, which is necessary for the diet therapy and the healthy slimming of the person who brings the health control terminal with oneself and stores the ingested energy information of the person who brings the health control terminal with oneself.

Therefore, the delicate health control support is capable of being given to the person who brings the health control terminal with oneself. At the same time, since the energy information of the food and drink is stored in the data base, the energy information is capable of being changed without changing information of the information medium associated with the food and drink, so that it becomes easy to control the information.

Alternatively, in the health control support system according to the tenth aspect of the invention, the network is connected to a terminal device of specific institutions including a medical institution for instructing the health control to the person who brings the health control terminal with oneself so as to access the ingested energy information of each person who brings the health control terminal with oneself, which is stored in the data base of the control device.

Therefore, in the specific institutions including the medical institution, it is easy to obtain the energy ingested information of the person who brings the health control terminal with oneself or the like and the instruction associated with the diet therapy and the healthy slimming can be appropriately performed, so that the effects of the diet therapy and the healthy slimming can be improved.

What is claimed is:

1. An information medium associated with a food and drink, including the information medium such as a package or the like of a meal menu and the food and drink, wherein information showing an ingested energy of each food and drink is patterned in a predetermined format and recorded.

2. A health control terminal, which is formed so as to be portable, comprising:
reading means for reading a record, which is patterned in a predetermined format as information showing an ingested energy of a food and drink in an information medium associated with the food and drink;
decoding means for decoding the ingested energy of said food and drink from said read information of the reading means;
transmitting means for transmitting a radio signal for transferring the energy information, which is decoded by said decoding means, to a predetermined device;
receiving means for receiving a radio signal to be returned with respect to the radio signal, which is transmitted by said transmitting means, as health control information of a person who brings the health control terminal with oneself associated with the ingested energy of said food and drink; and
informing means for informing the health control information, which is received by said receiving means.

3. A health control terminal, which is formed so as to be portable, comprising:
reading means for reading a record, which is patterned in a predetermined format as searching information for searching an ingested energy of a food and drink in an information medium associated with the food and drink;
decoding means for decoding said searching information from the read information of the reading means;
transmitting means for transmitting a radio signal for transferring said searching information, which is decoded by the decoding means, to a predetermined device;
receiving means for receiving a radio signal to be returned with respect to the radio signal, which is transmitted by said transmitting means, as health control information of a person who brings the health control terminal with oneself associated with the ingested energy of the food and drink, which is searched by said searching information; and
informing means for informing the received health control information, which is received by said receiving means.

4. A health control terminal, which is formed so as to be portable, comprising:
physical exercise quantity measuring means for measuring the physical exercise quantity of a person who brings the health control terminal with oneself;
reading means for reading a record, which is patterned in a predetermined format as searching information for searching an ingested energy of a food and drink in an information medium associated with the food and drink;
decoding means for decoding said searching information from said read information of the reading means;
transmitting means for transmitting a radio signal for transferring the physical exercise quantity, which is measured by said physical exercise quantity measuring means or the searching information, which is decoded by said decoding means, to a predetermined device;
receiving means for receiving a radio signal to be returned with respect to the radio signal, which is transmitted by said transmitting means in order to transfer the searching information to a predetermined device, as health control information of a person who brings the health control terminal with oneself associated with the ingested energy of the food and drink, which is searched by said searching information; and
informing means for informing the received health control information, which is received by said receiving means.

5. A health control terminal according to claim 2 or claim 3 or claim 4, having a function of a cellular phone to enable a phone call by voice.

6. A health control terminal according to claim 2 or claim 3 or claim 4 or claim 5, having means for inputting and setting the information, which is decoded by said decoding means, as various parameters, which are necessary for the operation of said terminal.

7. A health control terminal according to claim 2 or claim 3 or claim 4 or claim 5 or claim 6, having a detachable storage medium and means for reading and writing the information, which is necessary for the health control of said person who brings the health control terminal with oneself, with respect to said storage means.

8. A health control support system comprising:
a health control terminal to be brought with a person who requires a diet therapy and health slimming;
a control device having a data base, in which the information associated with the health of each person who brings said health control terminals with oneself is stored; and
a network for enabling transmission and reception of the information between said health control terminal and the control device; wherein said health control terminal comprises reading means for reading a record, which is patterned in a predetermined format as information showing an ingested energy of a food and drink in an information medium associated with the food and drink, decoding means for decoding the ingested energy of said food and drink from said read information of the reading means, transmitting means for transmitting a radio signal for transferring the energy information, which is decoded by said decoding means, to said control device, receiving means for receiving a radio signal to be returned with respect to the radio signal, which is transmitted by said transmitting means, as health control information of a person who brings the health control terminal with oneself associated with the ingested energy of said food and drink and informing means for informing the health control information, which is received by said receiving means; wherein said control device is constructed in such a manner that it returns the health control information, which is necessary for the diet therapy and the health slimming of said person who brings the health control terminal with oneself, associated with the ingestion of said food and drink and stores the ingested energy information of said person who brings the health control terminal with oneself on the basis of the energy information to be transmitted from said health control terminal and the information of the person who brings said health control terminal with oneself, which is stored in the data base.

9. A health control support system comprising:
a health control terminal to be brought with a person who requires a diet therapy and health slimming;
a control device having a data base, in which the information showing an ingested energy of a food and drink, which is provided by a catering establishment and the food and drink, which is sold by a delicatessen shop is stored in advance; and
a network for enabling transmission and reception of the information between said health control terminal and the control device; wherein said health control terminal comprises reading means for reading a record, which is patterned in a predetermined format as searching information for searching the ingested energy information of said food and drink in an information medium associated with the food and drink, decoding means for decoding said searching information from said read information of the reading means, transmitting means for transmitting a radio signal for transferring the searching information which is decoded by said decoding means, to said control device, receiving means for receiving a radio signal to be returned with respect to the radio signal, which is transmitted by said transmitting means, as health control information of a person who brings the health control terminal with oneself associated with the ingested energy of the food and drink, which is searched by said searching information and informing means for informing the health control information, which is received by said receiving means; wherein said control device is constructed in such a manner that it returns the ingested energy information of the food and drink, which is searched by the searching information to be transmitted from said health control terminal, in the energy information of the food and drink, which are stored in said data base, as the health control information, which is necessary for the diet therapy and the healthy slimming of said person who brings the health control terminal with oneself and stores the ingested energy information of said person who brings the health control terminal with oneself.

10. A health control support system according to claim 8 or claim 9, wherein said network is connected to a terminal device of specific institutions including a medical institution for instructing the health control to the person who brings said health control terminal with oneself so as to access the ingested energy information of each person who brings the health control terminal with oneself, which is stored in the data base of said control device.
